(19) United States
(12) Patent Application Publication
(10) Pub. No.: US 2012/0037276 A1
(43) Pub. Date: Feb. 16, 2012

(54) Flip-n-rip portable chainsaw mill

(75) Inventors: Erik Granberg, El Sobrante, CA (US); Bruce Jackson, San Francisco, CA (US)

(73) Assignee: GRANBERG INTERNATIONAL, INC.

(21) Appl. No.: 12/806,516

(22) Filed: Aug. 16, 2010

(51) Int. Cl. B27B 1/00; B27B 17/00; B27B 15/00

(52) U.S. Cl. 144/378; 144/2.1; 83/794; 83/820

(57) ABSTRACT

The chainsaw apparatus of the present invention, comprising in part, a combination saw attachment and positioning assembly which in concert with a transverse guide rail assembly and a vertical level control assembly allows using a chain saw to alternatively make a cut or a series of cuts in either a vertical or horizontal plane, with said saw blade oriented in a longitudinal cutting direction, in a sawmill device; providing thus for making a cant without turning the log and for making dimensionally accurate cuts of lumber from a log or similar wood based substrate with a minimal number of cutting passes; a blade orientation fine tuning assembly allows of refining a true vertical or horizontal planar attitude of the blade. Two speed mechanical assist gantry travel and a double acting remote chain saw safety switch and throttle trigger control is also provided. No tools are needed to alter and maintain the planar arrangement of the chain saw or the position of the saw carriage section along the transverse guide rail assembly of the gantry of the sawmill. The apparatus is modular and can be assembled and used by one person and is transportable in a van or pickup.

### BACKGROUND OF THE INVENTION

1. Field of the Invention

This invention relates generally to a portable sawmill using a chainsaw for sawing logs into dimensional lumber. More specifically it relates to a sawmill using a chainsaw in a combination mounting and saw attachment framework that allows of a selectively chosen cutting of a log with the blade of the chainsaw being held in either a vertical or a horizontal planar attitude and the blade oriented for a longitudinal cutting along a length of the log; the mounting and attachment framework also allows of a modification for a use in sawmills other than the sawmill device of the invention by an addition of an accessory attachment section to a transverse guide rail assembly of the gantry of the invention.

2. Description of the Prior Art

A number of devices have been patented to serve these needs, including sawmills that use band saws, circular blade saws and chain saws as the cutting agent. These portable sawmills have come into greater use for the cutting of logs into lumber useable for building material as a means of eliminating the necessity of transporting harvested logs to a conventional saw mill for processing and as a means for small land holders and independent loggers to manufacture dimensional lumber from trees they have harvested.

### SUMMARY OF THE INVENTION COMMENTS ON SPECIFIC PRIOR ART PATENTS MAJOR LIMITATIONS OF ANY SAWMILLS CUTTING ONLY IN ONE PLANE

All of the immediately following saw mills allow making only a horizontally or a vertically aligned cut—although some do have tilt mechanisms allowing of beveled cuts, none of them allow precisely cutting at opposed angles in both the vertical and the horizontal plane. The current invention presents a great improvement over these mills because, 1. with a mono-planar cutting mill, formation of a cant preparatory to creating “dimensional” lumber requires that the log be turned, leveled and stabilized three times. Once a cant is formed, further binding and turning operations are required for creating “dimensional” lumber.

These operations lead to increased risk of injury, wasted labor time, decreased accuracy of cutting to true dimensional size and potentially decreased orthogonality of cut pieces due to the difficulty of re-situating the log at exact 90.degree angles during successive turning operations.

Another deficiency of many of these mono-planar cutting mills is that and no partial depth cuts can be made.

With a mill providing a positioning of a saw blade in a bi-planar, vertical and horizontal planar attitude, and with the saw blade in an orientation for a longitudinal cutting of a log, both Cants and completed dimensional lumber cuts can be made with a parent log left in an original, and unturned position within the mill.

None of the sawmills provides a means for creation of a fine tuning of the vertical or horizontal planar attitude of the saw blade such as is provided in the current invention. The advantage of this capability as it is provided in the current invention is that such fine tuning allows of a creation of a greater orthogonality of the cut pieces of wood.

Some of the mills provide that the log to be cut rests on the base framework of the mill, others have the log resting within but not upon the mill framework. The current invention is arranged with an extensible modular base frame in which the log rests within the base framework but does not rest upon any portion of the base framework of the sawmill; with no log weight on the frame members there are reduced stresses on the framework, allowing of a use of a lighter and therefore more portable framework; and, there is a reduced chance of distortion of the framework; also, the log can absorb saw vibrations without transferring them to the mill works if the log is not on the base frame.

Another important feature found in the current invention is a dual acting remote safety switch and throttle trigger control means which utilizes a control cable controlled from a single control handle to provide a disengagement and a reactivation of a built in safety switch and an activation of a throttle control trigger of the chain saw; a full speed control from a slow idle to a full speed throttle setting is allowed; thus providing an advantage by an allowance of a use of a higher speed of rotation for cuts in a harder wood, or a slower blade rotation in a softer wood source.

A mechanically assisted gantry travel component of the present invention utilizes a two speed transmission in concert with a system of pulleys, gears and ropes to provide allowance of a slower speed more suitable for a cutting run of a blade through a log, or, a double speed for use during a non-cutting, return movement to a base end of the log; this results in a considerable saving of time in the course of a work run.

The present invention also uniquely provides an automatic control of the vertical level of the saw carriage assembly such that a series of successive cuts made in a horizontal plane of cutting can be made without a need for remeasurement or checking log caliper indicators; the major advantages include 1. improved accuracy of the thickness of sections of dimensional lumber since remeasurement errors are eliminated; 2. saving of time and labor.

An integral lateral position locking assembly of a body section of the invention allows a creation of a fixation of the saw at any given point in a right to left lateral direction across a full width of the gantry with the blade in either the vertical or horizontal cutting plane. The lock assembly is engaged and disengaged by simply tilting a handle of a toggle lock assembly. Another advantage is that while making a horizontal cut, the lock is left in a locked position during only about an inch of initial cutting following which it is unlocked, the pull of the saw blade then self-adjusts the saw against the side of the log in accord with any alteration of the log surface; this assures that a motor end of the sawblade bar is always involved in the cut, improving the quality of the cut surface. A further advantage is that with the saw against the side of the log throughout the cut, a thrust of the saw created by a rotation of the saw blade is absorbed by the log rather than being transferred to the gantry frame; this transfers less stress to the gantry and results in a diminution of vibration that in turn leads to a smoother and more accurate cut in a piece of dimensional lumber being milled.

### SUMMARY COMMENTS ON SPECIFIC PRIOR ART

In the following Summary Comments any distinguishing feature that has been covered by the preceding comments will not be dealt with again in the discussion of the following patents; the comments will only address major distinctions between any claimed matter in the named prior art and an aspect of the current invention in which the claimed matter of the current invention represents an improvement over the prior art.

U.S. Pat. Application No. 070234689 (DALE): Horizontal cut chain saw: SUMMARY COMMENTS: Manual Push for Travel; claims a remote throttle control—BUT no remote control of Safety switch is taught or claimed; no automatic vertical height return for successive cuts in horizontal plane; log to be cut rests on base frame of device.

U.S. Pat. No. 4,640,170 [BAKKEN] a portable horizontal cut Chain saw with both ends of the blade bar clamped within the gantry frame; Gantry has sliding foot plates for movement along a leveled ground surface—this mitigates against accuracy of cutting lumber to true dimensional sizes since absolute leveling of the land is not likely; vertical height adjustment is taught; a pair of interconnected screw drive rods having their lower ends affixed atop the two bar clamp assemblies is the height adjusting means, other than the inherent resistance of those threaded elements no provision is taught/claimed for holding the saw at a given vertical height; No automatic vertical height return for successive cuts is taught; No remote throttle and safety control switch element is taught; No mechanically assisted travel control mechanism is taught.

U.S. Pat. No. 3,926,086 [CRANE] horizontally cutting chainsaw. SUMMARY COMMENTS: A remote trigger disengagement control is taught, when the saw reaches the end of a cutting run, a detent that was manually pre-set to over-ride the chain saw safety device trigger is disengaged, the motor returns to idle speed and the safety switch is in an engaged position. No provision is taught for a range of throttle speed control by a remote throttle device; no provision is taught for remote reactivation of the safety switch and throttle trigger. A mechanically assisted travel mechanism taught does not have 2-speed gearing as does that of the incident invention, but, the rotating drive handle is at the end of the sawmill frame as opposed to the current invention where the operating handle is associated with the saw carriage section of the gantry, thereby providing immediate viewing of the log section being cut and allowing for speed control based on immediate observation of harder sections, burls, etc. The log rests on the base frame of the mill.

U.S. Pat. No. 5,243,892 [JINDRA] a vertical cut chain saw; SUMMARY COMMENTS: No provision is taught for setting and maintaining a vertical depth of cut other than a full depth cut. An extensible, modular base is taught, however, the log is supported on the end sections of the base of the sawmill. No remote throttle/safety switch is taught, nor is a mechanically assisted travel mechanism taught; the chainsaw is supported by a transversely slideable holder on a top cross piece of the saw carriage frame such that the chain saw can be positioned at various points across the width of the sawmill by a chain drive mechanism.

U.S. Pat. No. 3,889,560 [MACFADYEN] teaches a horizontal chain saw mill. SUMMARY COMMENTS: log is supported on a cross frame of the mill; the chain saw attachment means is undisclosed; means control the vertical height of the cradle and control its location across the diameter of the wood piece to allow cuts of differing thickness. The vertical control means taught involves several manually performed operations that must be performed prior to being able to use a moveable endless chain and geared rod arrangement as a means to alter and re-stabilize the level of the blade's cutting plane;

U.S. Pat. No. 5,784,941 [SANBORN] chain saw clamped vertically tip upwards within a saw carriage. SUMMARY COMMENTS: As opposed to the current invention, the setworks for adjusting the saw position for lateral position of cut is separate from the attachment means holding the saw to the carriage. A throttle activator is taught that keeps the saw motor at full cutting speed during a cutting run, an end of run device automatically returns the saw to idle speed during the return pass; no direct throttle control of the cutting speed by the operator is taught. No remote operation of the chain saw safety switch is taught. Log rests on the mill frame based member. A single speed travel mechanism is described.

U.S. Pat. No. 4,307,641 [SHAPLEIGH] horizontal cut chainsaw. SUMMARY COMMENTS: The log rests within and is supported by the mill frame. Means for altering the vertical elevation of the saw blade comprise a pair of rotatable vertically oriented adjusting screws, each surmounted by a control handle. Full through cuts are the only cuts allowed; manual sliding means of the gantry are taught, but no mechanically augmented dual speed control is taught.

U.S. Pat. No. 4,300,428 [WOODLAND] vertical cut chain saw. SUMMARY COMMENTS: log is held on the mill frame structure; the saw carriage allows lateral adjustment of the saw position but is restricted to the use of predetermined lock points using a series of laterally spaced apertures to provide the width adjustment stopping points; the current invention, advantageously allows lateral locking at any point along the full lateral width of the gantry. A pair of scissor jacks serving as the log support provide vertical control of the cut by elevation of the log itself, the saw carriage remaining at a given height; vertical or tilted angle cuts are possible, but cutting in a 90 degree opposed vertical or horizontal plane is not taught.

U.S. Pat. No. 7,444,912 [FENTON] a vertical cut circular blade mill using two cutting blades set to revolve in opposite directions. The blades are mounted on a carriage that allows inversion of the saws such that at the end of the first cut, the saw is flipped over and the opposite rotating blade can make a cut on the return movement of the saw carriage along the length of the log. SUMMARY COMMENTS: As with other blade saw mills, blade radius limits the size of log that can be cut with a device such as Fenton's while still maintaining portability of the unit; a 15″ log requiring a blade of at least 3 foot diameter, etc. Blades of this type are expensive and when they require sharpening they must be sent to special saw sharpening facilities that can handle the larger size blades. Replacement blades are not readily available at everyday retail sources. Log rests on the mill frame. The blade carriage unit remains at a given height and vertical height control is via altering the log support height.

U.S. Pat. No. 4,711,032 [RICKMERS] horizontal cutting band saw. SUMMARY COMMENTS Means of altering the vertical level of the saw blade comprise a control handle affixed to a threaded screw attached below to the mill base such that turning the handle moves the upper, saw support element to or from the base elements of the mill; making an initial cut, requires placement and leveling of a pair of externally applied leveling rails; following the first cut the leveling rails are removed and the saw carriage rides on top of the log surface itself.

### Patents Teaching Bi-Planar Cutting

U.S. Pat. No. 5,213,020 [ELGAN] band saw that cuts bi-directionally in both the horizontal and vertical cutting planes. SUMMARY COMMENTS: The log sits on lower mainframe of mill; As opposed to the hinge action of the chain saw positioning component of the current invention wherein the hinge rotation that provides for a 90.degree planar blade rotation is along the longitudinal axis of the Mill frame/Gantry, the hinge action in Elgan occurs along the transverse axis of the mill frame/gantry—so Elgan's cuts are horizontal along the length of the log but in the vertical plane the cut is transverse across a diameter of the log; the current invention allows full length horizontal and vertical cutting, allowing making multiple sections of dimensional lumber with far fewer cuts than Elgan. The vertical elevation of the saw carriage is done with a hydraulically driven pair of unending chains passing around pulleys at top and bottom of mill gantry. A hydraulic controlled chain drive is used for gantry travel along mill base.

U.S. Pat. No. 5,819,626 [LUCAS] a blade-saw mill making both horizontal and vertical cuts; SUMMARY COMMENTS: All limitations of blade saws in general apply to this device. The vertical level control means of the saw carriage is by four slidably mounted collars, mounted on uprights of the two vertical end frames of the mill framework; turning a control handle with a rope wound on a top axle of the end frame at both ends of the mill is required to move a pair of longitudinal guide rails up or down for vertical level control. No automatic sequential depth of horizontal cut is taught; no integral lateral positioning locking is taught. As with Elgan, Lucas provision for planar blade rotation occurs along the transverse axis of the mill frame/gantry creating the same problems listed prior for Elgan.

U.S. Pat. No. 4,584,918 [STUBBE] blade-saw making both horizontal and vertical cuts. SUMMARY COMMENTS: All general limitations of blade saws apply. The log is supported on the mill base frame. As an example of the limitation of log sizes cuttable by blade saws, Stubbe teaches an ability to cut logs up to a nominal dimension of six inches by six inches by using a sixteen inch blade; this requires an 85 pound 10 horsepower motor—using a 24 inch blade requires an 18 horsepower motor. Lifting and fitting such motors into place in rough terrain where they are likely to be used is one problem, another is, the effects of the heavy motor weights on the side cantilevered longitudinal rails of the mill. There is a rope and pulley vertical adjustment mechanism, however no automatic return to a selected depth of horizontal is taught. Both horizontal and vertical plane longitudinal cuts are possible; however, the saw automatically repositions such that traverse away from the operator is in the vertical plane and the return is in the horizontal plane—this means that only a partial depth cut resulting in one piece of dimensional lumber can be made with each full passage of the saw out and back—as opposed to the current invention where, following a series of horizontal cuts at a preferred dimension, each subsequent vertical pass creates multiple sections of dimensional lumber.

### General Summary Comments on Bi-Planar Cutting Band and Blade Sawmills

Band saw setups allowing of Bi-planar cutting would require interrupted cutting and removal of boards during the cutting operation in logs having a diameter greater than the width of the gap between the cutting aspect and the return aspect of the band saw blade; making multiple dimensional sections in a log of any greater diameter requires that cut wood must be removed during the sawing operation rather than following a full pass along the log; they also require at least two turnings, repositionings and levelings of the log after making an initial top cut in order to create a cant.

One suggested advantage of using a band saw is that band saws have a thinner kerf, and thus leave less waste due to blade width loss, however other sources cite that it is hard to keep a band saw blade tracking a straight line through a round log, and grain resistance can lead to boards having a wavy or undulating surface when they are cut by band saw blades. This leads to waste due to the inaccurate dimension of the finished lumber. Band saws are high maintenance and maintaining proper blade tension is critical.

Blade saw mills, even if capable of cutting both vertically and horizontally are limited to cutting logs within slightly less than their blade diameter; to cut larger logs, very large blades must be used, these larger blades require more substantial and stronger motors and frameworks, increasing the weight and difficulty of transport, set up and disassembly of such units as well as the cost of the mill.

### Basic Advantages of Chain Saws Over Band and Blade Saws

Relative to a saw arrangement that allows cutting in only one planar arrangement, or to either a blade of band saw that allows bi-planar cutting, a chain saw arrangement that allows cutting in both the vertical and horizontal plane along the longitudinal length of a log allows for much more rapid production of dimensional lumber because a successive series of horizontal through cuts of a given thickness could be followed immediately by a series of vertical through cuts at a given desired width to create a full stack of boards at each vertical pass down the length of the log without the need to band and turn the mass of boards at any time.

Another advantage of the chain saw arrangement of the incident application is that it also allows for cutting a series of partial depth cuts at one or differing widths to be followed by a horizontal through cut at a desired thickness, thus allowing sequential creation of dimensional lumber of differing dimensions from the same log and with a minimal number of cutting passes as well as no turning of the cant or log.

### Other Special Features of the Present Invention

### Vertical Level Control Mechanisms

The vertical level control mechanisms of all cited patents and applications fall into one of the following categories of mechanism. 1. Threaded rod and crank handle, 2. gears with threaded rod and/or pull chain, 3. threaded scissor jack log support, pulley, rope and crank handle, stationary saw platform with log platform that is vertically adjustable, hydraulic powered continuous chain rotating upper and lower pulleys with a chain affixed to a slidable frame element.

In the present invention, as will be described later the establishment of the vertical level of the cutting blade is achieved by the use of a unique stationary chain and climbing sprocket arrangement; the arrangement has a positive lock ability to hold the blade stably at any given level of vertical orientation within the sawmill apparatus. This vertical level control is functional with the saw blade being held in either a vertical or a horizontal orientation within the sawmill.

### Synopsis: Description of the Invention

The present invention comprises a portable log cutting apparatus and system for a making of dimensional lumber from a log or other material suitable for cutting by a chainsaw; the chainsaw being held in a readily detachable but secure affixation to a body section of a chain saw attachment and positioning carriage framework assembly by a chainsaw bar attachment assembly component of the carriage framework assembly; the saw carriage framework assembly being in a situation within a gantry portion of a sawmill apparatus.

The carriage framework assembly is designed such that a hinged saw blade orientation component of a body section of said framework allows of a selectable positioning and maintenance of a planar orientation of a blade of the chain saw in either of a vertical or a horizontal planar cutting attitude, with a saw blade oriented for making a longitudinal cut along a log; thus allowing a user to make a selectively chosen horizontal or vertical cut or series of cuts in a longitudinal direction into and through the log or other suitable substrate material.

The body section of the carriage framework further providing for a moveable attachment of the carriage along a pair of transversely situated guide rails of a transverse guide rail assembly of said gantry; said transverse guide rail assembly allowing of a movement of or alternatively, a fixation of the chainsaw at a selected horizontal position within the full width of the gantry.

A vertical level control assembly allows a movement of or alternatively, a fixation of the chainsaw at a selected vertical level within a full height of the gantry of the sawmill.

Acting in combination, the saw carriage assembly the vertical level control assembly and the transverse guide rail assembly uniquely create an allowance of an ability to make either a vertically oriented cut or series of cuts, or a horizontally oriented cut or series of cuts, of a through cut or partial depth cut nature in a selectably alternating manner in a longitudinal direction along a full length of the log or other substrate material with the log or other substrate being left in an unturned and original position within the sawmill apparatus, and, further providing an ability for a making of a cant from the log with the log being left in its unturned and original position within the sawmill apparatus;

A base section of the sawmill apparatus is of a modular nature and is extensible to a full length of the log or other chainsaw cuttable material.

An automatically regulated control of a thickness of a horizontally oriented cut is afforded by a horizontal cut thickness gauge assembly and provides for a repeatable dimensional thickness of the cut pieces, and a saving of labor time by eliminating any need for remeasurement/calibration between cutting passes.

A dual acting remote throttle control allows a full speed range remote control of the chainsaw throttle while also affording a remote safety lock control function of the chainsaw.

A mechanically assisted dual speed bi-directional gantry travel mechanism is used.

The carriage assembly and a typical sawmill apparatus necessary for its use can be carried, set up and operated by one person and is transportable in a van, or a pickup vehicle.

A more complete description may be found in the appended claims.

### OBJECTS OF THE INVENTION

It is an object of this invention to provide a sawmill device that allows of a bi-planar cutting in a longitudinal plane of cutting of a log or other material suitable for cutting by a chainsaw, into a series of specifically sized dimensional sectional pieces by using a chainsaw that is mounted on a carriage that allows of a cutting in both a horizontal and a vertical plane of orientation.

Another object is to provide a sawmill device in which the distorting effects of saw blade vibration are minimized, thereby helping to provide maximal accuracy of cutting lumber to dimensional size, and, in which a saw blade attachment device allows the log being cut to absorb the saw thrust, thus providing a reduction of strain on the sawmill framework.

Still another object is to provide a saw carriage and blade orientation device allowing biplanar cutting, which said device is adaptable for use on other sawmill frameworks.

It is a further object to provide a device framework that easily allows a manual changing of a planar attitude of a cutting head without the use of tools while maintaining orthogonality of a support framework of the device, and which said device provides a fine-tuning mechanism allowing of optimizing the blade cutting angle within either of a horizontal or a vertical cutting attitude.

Another object is to provide a means to remotely and fully operate both a saw throttle and a safety switch feature associated with a chain saw's throttle controls.

A further object is to provide a framework and sawmill apparatus that is easily transported in a pick up or such vehicle, and that can be set up and operated by one person.

Another object is to provide a device that minimizes the time and effort of squaring a log to form a cant prior to a cutting of a lumber or other such substrate to dimension, thus saving time and energy and providing maximal accuracy of cuts made in the opposed vertical and horizontal planes.

Another object is to provide a mounting system for the chain saw that allows a quick disconnect of the saw so that the saw can be used temporarily for purposes of a trimming or bucking of a parent wood source and then returned to the mill for use.

Another object is to provide a device allowing the use of both a relatively small or a large chain saw.

### BRIEF DESCRIPTION OF THE DRAWINGS

FIG. 1a presents an oblique view of the carriage viewed from a right superior aspect of the device in accordance with the invention; the carriage is arranged with the saw blade orientation section prepared to situate the saw blade in a horizontal cutting position.

FIG. 1b present a horizontal rear end view with a portion of a chain saw seen situated in a horizontal cutting attitude.

FIG. 2 presents an “exploded” view of the same oblique view as was seen in FIG. 1a; the basic body; integral lateral lock mechanism; hinged, saw blade orientation assembly and the chainsaw bar attachment component are distinguished between.

FIG. 3 presents a series of drawings:
Upper Left drawing: oblique view of body with integral lateral locking mechanism and all external attachment sections removed; as seen from the rear looking down onto the right side and the base of the body section.
Upper Central drawing: same segment as seen from a straight horizontal rear view.
Upper Right drawing: Oblique view of the L shaped hinged attachment plate section shown with the base section vertical and the right side section horizontal as seen from the right rear and superior to the internal aspect of the side wall section.
Lower Left drawing: A horizontal rear end view of the body, as was shown in the Upper Central view, with the additional inclusion of the L shaped hinged attachment plate. Line A—A represents a vertically oriented front to back longitudinal cut though a central line of the body
Lower Central drawing: A view of the internal aspect of the right side of the body in accord with the section depicted in the lower left drawing, with the rear of the body rotated to the right in the drawing.
Lower Right drawing: an oblique view from a right rear superior aspect, showing the body with the hinged attachment plate positioned such that the saw blade (not shown) would be oriented for cutting in the perpendicular plane.

FIG. 4a: an exploded view of the components comprising the hinged attachment plate and the saw attachment components of the device as seen from a right rear superior oblique aspect.

FIG. 4b Top view: a bottom view looking up through the chainsaw bar attachment component.
Central view: side view of the chainsaw bar attachment component.
Bottom view: frontal view of the chainsaw bar attachment component showing a section of the bar and blade contained within the clamping pads.

FIG. 5a: The sawmill apparatus, including the carriage device of the current invention as seen in an end view from the rear.

FIG. 5b: The sawmill apparatus, including a base section, a log represented in a form of a cant; a gantry, a carriage device of the current invention as seen from a rear right superior viewing point. NOTE: the front end section is truncated but is an exact mirror image of the portion shown.

FIG. 5c A left rear superior oblique view of the basic gantry frame and left rear gantry subframe components only; the basic gantry frame is shown exclusive of the gantry top forward travel section components.

FIG. 5d: a rear view of the Gantry Control Handle subframe separated from the gantry frame.

FIG. 5e: a view of the Sawmill Apparatus Base Frame Section looking down from an oblique right superior vantage point.

FIG. 5f: A view of the base frame with a rear and a front non-log bearing section fully assembled; a right side gantry track section of a log containing section of the base frame is shown assembled but disassociated from the base frame as it would be seen prior to loading a log within a confine of the base section.

FIG. 5g: An exploded view of the same parts seen in FIG. 5H.

FIG. 5h: A detail of the interconnection of a pair of Base Frame longitudinal Guide Rails, and of two sets of the Support and Leveling Feet of the base framework

FIG. 6a: A right rear superior oblique view of the carriage assembly of the invention with the chainsaw attached and situated in a horizontal cutting position.

FIG. 6b: A right horizontal side view of the carriage assembly of the invention with the chainsaw attached and situated in a perpendicular cutting position.

FIG. 7a: A left rear superior oblique view of the wheel fenders and basic vertical frame members of the gantry, and of the frame members of the transverse guide rail assembly members.

FIG. 7b: A left rear superior oblique view depicting a portion of a set of four basic vertical gantry frame members and their relationship to the components of a stationary vertical climbing chain mechanism that raises and lowers a transverse guide rail assembly within the gantry framework.

FIG. 7c: A close up view of the stationary Vertical Climbing Chain gear boxes, handle and associated members of the transverse guide rail assembly.

FIG. 7d: Presents an oblique view from a left rear superior aspect looking down towards the gantry with the removable components of the transverse guide rail assembly that bear the saw carriage component withdrawn from the gantry, as though preparatory to a modification of the assembly for a use in a sawmill device other than that of the incident invention.

FIG. 7e: Presents an oblique view from a rear right superior vantage point looking down at a modified guide rail assembly, bearing the saw carriage component of this invention and situated with a set of accessory wheels of the modified guide rail assembly situated on the longitudinal rails that extend above and along a length of a log to be cut within a sawmill device other than that of this invention; the view is rotated approximately 90.degree clockwise to the view depicted in FIG. 7d.

FIG. 7f: presents an exploded view showing details of a portion of the carriage assembly and a set of modification connection components, including a set of wheels that allow a use of the transverse guide rail assembly in other sawmill devices.

FIG. 8a: A left side rear superior oblique view depicting a left wheel fender and the left end vertical gantry frame members and their relationship to the components of the left end stationary vertical climbing chain mechanism components.

FIG. 8b: presents a close up of the left rear vertical climbing chain sprocket, a section of the left climbing chain axle and the upper and lower climbing chain sprocket idler wheels.

FIG. 8c: Presents an oblique view of the left end cross chain assembly as seen from a rear right superior viewing aspect.

FIG. 9a: As seen from a front right superior aspect, presents an oblique view of the carriage with a vertical cutting guide assembly in place and with a foot section of the guide lowered to a level for locking the carriage at a level providing a cut of a predetermined thickness before a subsequent cut is made.

FIG. 9b: As seen from a front right superior aspect, presents an oblique view of the carriage assembly with the vertical cutting guide assembly in place and with a foot section of the guide elevated and locked at a level above the log as during a cutting operation.

FIG. 10a: presents a left side view of the saw handle and the saw handle borne components of a dual acting remote chainsaw safety switch and throttle trigger control assembly.

FIG. 10b: presents a view of the left gantry subframe borne components of the dual acting remote chainsaw safety switch and throttle trigger control assembly.

FIG. 11a: presents a schematic diagram of a Dual Speed Gear box assembly and of a connection of the Gear box assembly to a connecting gear of a Gantry Top Travel Component of a mechanically assisted travel control mechanism of the gantry as taught in this invention.

FIG. 11b: presents a diagrammatic top view of a set of Gantry Travel Control Axles and an associated set of gears and connecting chains.

FIG. 12: presents a diagrammatic representation of the Travel Control gear box, gantry top travel control axles and associated gears and attachment members, including a set of travel control ropes and rope attachment cleats.

### DESCRIPTION OF A PREFERRED EMBODIMENT

### Sawmill Basics and Overview of the Invention

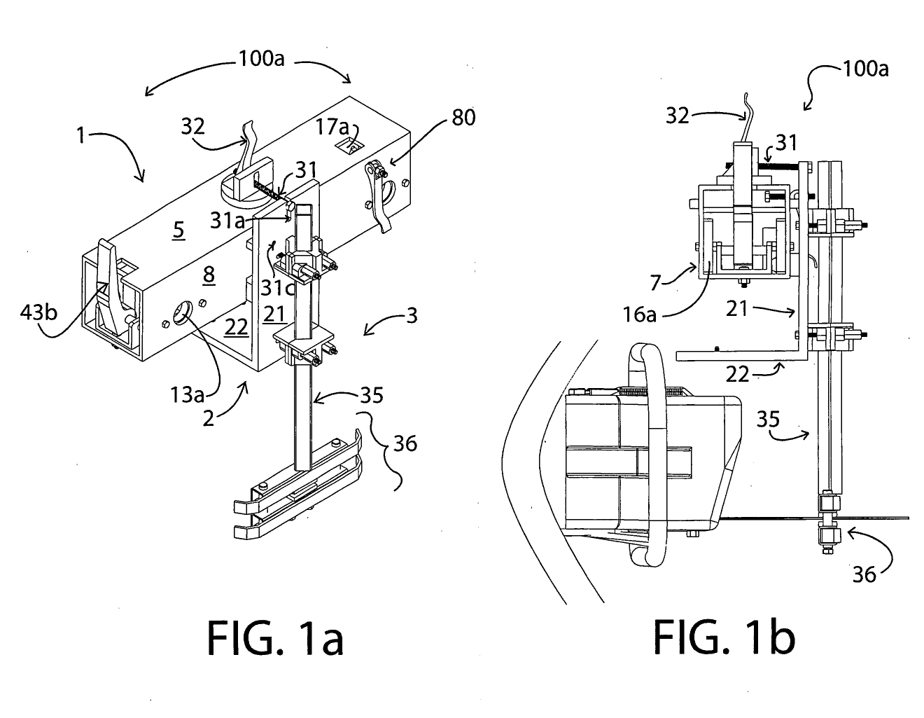

The present invention, a combination chainsaw attachment and positioning device, 100 FIG. 9a comprises in part a chain saw carriage assembly 100a FIG. 1a designed to allow use of a chain saw 400 FIG. 6a within a sawmill apparatus 500 FIG. 5b to make either a vertically oriented cut or series of cuts 501 FIG. 5b, or, a horizontally oriented cut or series of cuts 502 FIG. 5b in a selectably alternating manner with a saw blade disposed for cutting longitudinally in a log or another substrate material cuttable by a chainsaw 503 FIG. 5a, and doing so with said log or other substrate material being left in an unturned and original position within said apparatus; said attachment and positioning assembly further providing an ability for a making of a cant 503 FIG. 5b from said log with said log being left in said unturned and original position within said apparatus;

said chainsaw carriage assembly also allowing of a controlled and accurately maintained, variable but fixed depth of cut and variable but fixed width of cut of said chain saw in a perpendicularly oriented plane, or a horizontally oriented plane;

said ability of being able to make cuts in an alternating manner of cutting between an opposed pair of directions, perpendicular or horizontal, results in an ability to create multiple sections of dimensional lumber with a single pass of said chain saw following an appropriate number of preparatory cuts in an opposed plane of orientation, thereby allowing creation of said multiple sections of dimensional lumber with a minimal number of sawing operations.

Said chainsaw of said sawmill apparatus comprises in part a saw motor 401 FIG. 6a and a saw motor end 402 FIG. 6a, a saw handle 406 FIG. 6a, a saw blade bar 403 FIG. 6a bearing a saw blade 404 FIG. 6a and a saw bar nose end 405 FIG. 6a;

### The Gantry

said sawmill apparatus further comprises in part a gantry 510 FIG. 5b, which said gantry partially comprises a gantry main frame 510f best seen in FIG. 5C said main frame comprising in part a set of four vertical main frame supports, a rear left side main frame vertical support 510a FIG. 5c, a front left side main frame vertical support 510b FIG. 5c, a rear right side main frame vertical support 510c FIG. 5c and a front right side main frame vertical support 510d FIG. 5c;

each of which said vertical main frame supports is solidly affixed to one of a set of four vertical level adjustment assembly OC tubes (14a,14b,14c,14d, best seen in FIG. 7a), a left rear vertical level adjustment assembly OC tube 14a FIG. 7a, a left front vertical level adjustment assembly OC tube 14b FIG. 7a, a right rear vertical level adjustment assembly OC tube 14c FIG. 7a and a right front vertical level adjustment assembly OC tube 14d FIG. 7a;

said main frame vertical supports being held in an attachment with each other in such a manner as to form a rectangular top frame of said gantry main frame by a pair of transverse horizontal top main frame members (513,514 FIG. 5c) and three longitudinal horizontal top main frame members (511,512 and 531 FIG. 5c);

said longitudinal horizontal top main frame members comprising a left longitudinal horizontal top main frame member 511, FIG. 5c, a right longitudinal horizontal top main frame member 512, FIG. 5c, and a mid gantry longitudinal horizontal top main frame member 531, FIG. 5c

said transverse horizontal main frame members comprising a top rear transverse horizontal main frame member 513 FIG. 5c and a top front transverse horizontal main frame member 514 FIG. 5c;

said top rear transverse horizontal main frame member is attached at a topmost level and in a reinforced manner to said left end main frame member 510a; said reinforcement of said attachment is afforded by a roughly triangular rear left side transverse reinforcement plate 516a FIG. 5c; said top rear transverse horizontal main frame member 513 further being attached at a topmost level and in a reinforced manner to said right end main frame member 510c; said reinforcement of said attachment is afforded by a roughly triangular rear right side transverse reinforcement plate 516c FIG. 5c;

a left end of said top front transverse horizontal main frame member 514 is attached at a topmost level and in a reinforced manner to said front left end main frame member 510b; said reinforcement of said attachment being afforded by a roughly triangular front left side transverse reinforcement plate 516b FIG. 5c;

a right end of said top front transverse horizontal main frame member 514 being attached at a topmost level and in a reinforced manner to said front right end main frame member 510d; said reinforcement of said attachment being afforded by a roughly triangular rear right side transverse reinforcement plate 516d FIG. 5c;

said left longitudinal horizontal top main frame member 511 FIG. 5c is welded at a front end to a rear facing aspect of said front transverse horizontal main frame member 514, and welded at a rear end to a forward facing aspect of said rear transverse horizontal main frame member 513;

said top mid gantry longitudinal horizontal frame member 531 FIG. 5c is welded at a front end to a rear facing aspect of said front transverse horizontal main frame member 514, and welded at a rear end to a forward facing aspect of said rear transverse horizontal main frame member 513;

said right longitudinal horizontal top main frame member 512 FIG. 5c is welded at a front end to a rear facing aspect of said front transverse horizontal main frame member 514, and welded at a rear end to a forward facing aspect of said rear transverse horizontal main frame member 513;

said rear left side vertical main frame support member 510a and said front left side vertical main frame support member 510b each terminating below in a welded attachment to a left side fender member 517 FIG. 5c; said fender member partially comprising a three sided inverted U shaped tubular member having an open side facing downward 517a FIG. 5c, said tubular member containing a pair of gantry wheel and axle sets, a rear left gantry wheel and axle 517b FIG. 5c and a front left gantry wheel and axle 517c FIG. 5c;

said rear right side vertical main frame support member 510c and said front left side vertical main frame support member 510d each terminating below in a welded attachment to a right side fender member 518 FIG. 5a; said fender member partially comprising a three sided inverted U shaped tubular member having an open side facing downward 518a FIG. 5a, said tubular member containing a pair of gantry wheel and axle sets, a rear right gantry wheel and axle 518b and a front right gantry wheel and axle 518c;

the whole being so arranged and affixed in and between each other as to form a stable superstructure situated upon and capable of being moved in a forward or a backward manner along a pair of longitudinal gantry tracks 505 a,b,c,d,e,f FIG. 5e of a base section 580 FIG. 5e of said sawmill apparatus upon which said base section said log or said other chainsaw cuttable substrate is held and stabilized.

### Gantry Travel Components of Upper Gantry Frame

A pair of upper gantry travel drive axles 520,524 FIG. 5b a front upper gantry travel axle 520 FIG. 5b and a rear upper gantry travel axle 524 FIG. 5b are seen spanning a full left to right width across said gantry between said top rear transverse horizontal main frame member 513 and top front transverse horizontal main frame member 514; said pair of upper gantry travel axles each being held in a rotatable position within a set of pillow blocks; a left end upper rear gantry travel axle pillow block 525 FIG. 11b, a mid axle upper rear gantry travel axle pillow block 526 FIG. 11b and a right end upper rear gantry travel axle pillow block 527 FIG. 11b of said upper rear gantry travel axle 524; and a left end upper front gantry travel pillow block 521 FIG. 11b, a mid axle upper front gantry travel pillow block 522 FIG. 11b and a right end upper front gantry travel pillow block 523 FIG. 11b of said upper front gantry travel axle 520;

Said left end pillow blocks 521 and 525 being bolted to a top surface of said top left side horizontal main frame member 511 and said right end pillow blocks 523 and 527 being bolted to a top surface of said top right side horizontal main frame member 512; said mid axle pillow blocks 522 and 526 being bolted to a top surface of top mid frame horizontal main frame member 531;

a right end of said upper front gantry travel axle 520 terminates in a right front upper travel axle sprocket 530 FIG. 11b; a right end of said upper rear gantry travel axle 524 terminates in a right rear upper travel axle sprocket 529 FIG. 11b; a left end of said upper rear gantry travel axle 520 terminates in a left rear upper travel axle sprocket 532 FIG. 11b.

### Gantry Control Handle Subframe (For Travel and Trigger Handles)

Said rear left side vertical main frame support 510a FIG. 5c bearing and being welded to a pair of left rear subframe horizontal connector members 541a,541b FIG. 5d; an upper, left subframe horizontal connector member 541a FIG. 5d and a lower, left subframe horizontal connector member 541b FIG. 5d, which said connectors comprise part of a left rear vertical subframe assembly 541 FIG. 5d.; said subframe assembly 541 further comprising a vertically positioned OC tube 541c FIG. 5d with an opening of said OC tube 541d FIG. 5d facing rearward, said OC tube being affixed above at a topmost level to a lateral most end of said upper connector 541a and at a bottom most level to said lower connector 541b, forming thus a framework (541a,b,c) FIG. 5d; of said vertical subframe assembly 541;

### Mechanically Assisted Gantry Travel Control Assembly

Said left subframe assembly 541 FIG. 5d also further partially comprises a mechanically assisted travel control assembly of said gantry, which said assembly comprises in part a dual speed transmission assembly and an upper gantry travel axle component as well as a gantry travel rope component;

a gantry travel control handle assembly 89 FIG. 5d; comprises a horizontally situated forward travel control handle handgrip section 89a FIG. 5d, which, following a 90 degree angle bend terminates as a vertically situated forward travel control handle axle 89b FIG. 5d, which said axle 89b passes into and is in a rotatable affixation within a travel control handle attachment bracket 89c FIG. 5d which said bracket is affixed to said vertically positioned OC tube 541c of said left vertical subframe assembly 541 of said gantry; within a confine of said bracket 89c;

said control handle axle 89b bears a set of three control handle axle gears (90,91,92 FIG. 11a; a larger, laterally situated high speed gear 90 FIG. 11a, a mid axle low speed gear 91 FIG. 11a and a most centrally situated vertical travel chain drive gear 92 FIG. 11a; said axle also bearing and being transfixed by a gear lock pin 93 FIG. 11a, which said gear lock pin is located at a position between said high speed and said low speed gears 90,91;

said low speed gear 91 FIG. 11a being of a diameter and a gear tooth arrangement the same as a diameter and a gear tooth arrangement of said vertical travel chain drive gear 92 FIG. 11a; said low speed gear and said vertical travel chain drive gear being in a permanent state of fixation to each other;

a transmission axle 94 FIG. 11a bears a pair of transmission gears 95,96 FIG. 11a, an external transmission gear 95 and an internal transmission gear 96; said transmission axle 94 is situated and held in said bracket 89c at a level slightly below and in an alignment with said control handle axle 89b;

a closed loop external transmission gear chain 97 FIG. 11a serves as a permanent interconnection between said high speed gear 91 FIG. 11a and said external transmission gear 95 FIG. 11a; a closed loop internal transmission gear chain 98 FIG. 11a serves as a permanent interconnection between said low speed gear 91 and said internal transmission gear 96;

both of said transmission gears 95,96 FIG. 11a are in a permanent attachment to said transmission axle 94 FIG. 11a in such manner that a rotation of said transmission axle 94 results in a like direction rotation of both of said transmission gears said set of three control handle axle gears 90,91,92 FIG. 11a and said pair of transmission gears 95,96 FIG. 11a and said pair of transmission gear chains 97,98 FIG. 11a,

when spoken of collectively hereinafter said set of control handle and transmission handle gears and chain interconnections being referred to as a gantry travel transmission 99 FIG. 11a; said gantry travel transmission allowing of a selection of a high or a low travel speed in either of a forward or a rearward direction of said gantry along said base of said sawmill apparatus

all three travel handle axle gears 90,91,92 are situated in a free rotational state on said handle axle 89b; said axle can be moved along a transverse axis within said bracket such that said gear lock pin 93 FIG. 11a can be left in a neutral position, a position where said gear lock pin is not in an engagement with either the low or the high speed control handle axle gears; in such an instance, a rotation of said handle 89a leads to no rotation of any of the gears of said transmission 99;

a centrally directed movement of said axle 89b FIG. 11a serves to bring said pin 93 into an engagement within a slot in a lateral side of said slow speed gear 91, following said engagement of said pin in said slow speed gear, a rotation of said axle 89b FIG. 11a results in a same direction rotation of said slow speed gear 91 with a resultant like direction and 1:1 speed ratio revolution of a vertical continuous loop travel chain drive gear 101 FIG. 11a; in this situation, said lateral transmission gear 95 also rotates in a like direction, and drives said high speed gear 90 into a like rotation, said high speed gear rotating in a free wheeling state around said drive handle axle;
with a lateral movement of said axle 89b to bring said pin 93 FIG. 11a into an engagement within a slot in a lateral side of said high speed gear 90, a rotation of said axle 89b results in a same direction rotation of said high speed gear 90 with a resultant like direction and a 2.5:1 speed ratio revolution of said lateral transmission gear 95; in this situation, said rotation of said lateral transmission gear leads to a like directional rotation of said internal transmission gear 96 with a resultant like rotation of said internal transmission gear 98 chain leading to a like rotation of said slow speed travel handle gear 91 and its attached travel chain drive gear 92;

a lower end loop of a vertical continuous closed loop travel drive chain 101 FIG. 11a is in an engagement around said travel chain drive gear 92; after passing upwards through said gantry said vertical travel drive chain 101 is situated in an engagement around said left rear upper travel control axle sprocket 532 FIG. 11a, said sprocket 532 being situated at a left most end of said upper, rear travel control axle 524 FIG. 5b, said upper control axles are held in a connection by a continuous closed loop upper travel sprocket cross chain 102 FIG. 11b, which said cross chain is in an affixation around a pair of gantry travel upper cross chain sprockets 529,530 FIG. 11b, a right upper rear travel axle cross chain sprocket 529 FIG. 11b and a right upper front travel axle cross chain sprocket 530 FIG. 11b;

said upper travel cross chain 102 serving to impart a rotational movement from said upper rear travel control axle 520 to said upper front travel control axle 524 such that both of said axles 520,524 move in a unison and a like directional rotational manner in either of a forward or a backward rotation, said rotational movement being in an accord with a rotational movement of a forward or a backward turning of said travel control handle 89a FIG. 11a of said control handle assembly 89.

a set of synthetic cables (103,106,109,112 FIG. 12), hereinafter referred to as “a rope”, “a pair of ropes” or “ropes” partially comprise a mechanism for a transfer of a rotational movement of said handle 89a FIG. 11a into a forward or a backward movement of said gantry along said longitudinal guide rails 505 FIG. 5b; said set of ropes comprising a pair of front end gantry travel ropes (103, 106 FIG. 12) and a pair of rear end gantry travel ropes (109,112 FIG. 12);

a forward end of a front left gantry travel rope 103 FIG. 12 is in a fixed attachment to a cleat 104 FIG. 12 situated at a left side front facing surface of said base section of said gantry; said rope 103 FIG. 12 makes a lateral passage to a left front corner of said base, thence making a passage around said corner and thence back along a left side of said base of said gantry to a point beneath said front upper gantry travel axle 520, following a passage through an eye bolt 105 FIG. 12 said rope 103 is led in an upward turn and a passage upwards to a fixed attachment on said front upper gantry travel axle 520 FIG. 12 at a point slightly central to said pillow block 521 FIG. 12;

a forward end of a front right gantry travel rope 106 FIG. 12 is in a fixed attachment to a cleat 107 FIG. 12 situated at a right side front facing surface of said base section of said gantry; said rope 106 makes a lateral passage to a right front corner of said base, thence making a passage around said corner and back along a right said of said base of said gantry to a point beneath said front upper gantry travel axle 520, where, following a passage through an eye bolt 108 FIG. 12 said rope follows an upward path, ending in a fixed attachment on said front upper gantry travel axle 520 at a point slightly central to said pillow block 523;

a rearmost end of a rear left gantry travel rope 109 FIG. 12 is in a fixed attachment to a cleat 110 FIG. 12 situated at a left side rear facing surface of said base section of said gantry; said rope 109 makes a lateral passage to a left rear corner of said base, thence making a passage around said corner and thence forward to a point beneath said rear upper gantry travel axle 524 FIG. 12; where, following a passage through an eye bolt 111 FIG. 12 said rope follows an upward path, ending in a fixed attachment on said upper rear gantry travel axle 524 at a point slightly central to said pillow block 525 FIG. 12;

a rearmost end of a rear right gantry travel rope 112 FIG. 12 is in a fixed attachment to a cleat 113 FIG. 12 situated at a right side rear facing surface of said base section of said gantry; said rope 112 makes a lateral passage to a right rear corner of said base, thence making a passage around said corner following which it follows a path forward to a point beneath said rear upper gantry travel axle 524 FIG. 12, where, following a passage through an eye bolt 114 FIG. 12 said rope follows an upward path, ending in a fixed attachment on said upper rear gantry travel axle 524 at a point slightly central to said pillow block 527 FIG. 12;

following a selection of a gear pairing for a delivering of either of a lower speed or a higher speed of travel from said gears 90,91,92,95,96 FIG. 11a of said gantry travel handle control assembly 89 FIG. 11a, a turning of said gantry forward travel handle 89a, leads to either a forward or a backward rotation of said continuous closed loop vertical travel drive chain 101 FIG. 11a; said vertical travel chain drive turns said upper left rear travel sprocket 532 FIG. 11a in a like direction rotation to said rear upper gantry travel axle 524 FIG. 11b; concomitant with which a like directional rotation of said continuous closed loop upper travel sprocket cross chain 102 FIG. 11b imparted to upper travel axle sprocket 530 FIG. 11b by a rotational movement of said upper travel axle sprocket 529, leads to a like directional rotation of front upper gantry travel axle 520 FIG. 11b;

a forward rotation of said gantry travel control handle 89a FIG. 11a leads to a forward movement of said gantry along said longitudinal guide rails of said base of said sawmill apparatus; a rearward rotation of said gantry travel control handle 89a leads to a rearward movement of said gantry along said longitudinal guide rails 505 FIG. 5b of said base 580 FIG. 5b of said sawmill apparatus;

with said gantry in a situation at a rear most end of said gantry longitudinal guide rails said front right gantry travel rope 106 FIG. 12 and front left gantry travel rope 103 106 FIG. 12 are both in a fully extended and unwrapped state from said front upper gantry travel axle 520, and said rear right gantry travel rope 112 106 FIG. 12 and rear left gantry travel rope 111 106 FIG. 12 are both in a fully wound state upon rear upper gantry travel axle 524;

a forward gantry control handle rotation serving thus to create said forward movement of said gantry by an application of a pulling action on said pair of front gantry travel ropes 103,106 FIG. 12, said pulling action serving to create a wrapping of said pair of front gantry travel ropes upon said front upper gantry travel axle 520; simultaneously said pair of rear gantry travel ropes are led into an unwrapping from said rear upper gantry travel axle 524;

a rearward gantry control handle rotation serving thus to create said rearward movement of said gantry by an application of a pulling action on said pair of rear gantry travel ropes 109, 112 106 FIG. 12, said pulling action serving to create a wrapping of said pair of rear gantry travel ropes upon said rear upper gantry travel axle 524; simultaneously said pair of front gantry travel ropes are led into an unwrapping from said front upper gantry travel axle 520;

said gantry further partially comprises a transverse guide rail assembly 14 FIG. 7a, which said transverse guide rail assembly provides a mounting platform upon which said chain saw attachment and positioning assembly can be situated in a stable but removable manner within said gantry; said transverse guide rail assembly will be described in detail later.

### Vertical Level Control Assembly

said gantry further comprising a stationary chain vertical level control assembly 14 FIG. 7a, said stationary chain assembly providing a control of a vertical level of said sawblade with said saw blade in either of said perpendicular or said horizontal planar attitudes of orientation by imparting an upward or a downward movement of, and a fixation of said transverse guide rail assembly at any vertical position along a full height of said gantry;

said stationary chain vertical level control assembly thus allowing of a positioning and a locking into position of said saw for making said cuts or series of cuts in said log or other wood based substrate at an exact horizontal depth or an exact vertical width within said log or other chainsaw cuttable substrate;

said vertical level control assembly comprising in part a set of four vertically oriented stationary climbing chains 69a,b,c,d FIG. 8b a forward and a rearward left side pair of chains 69a,c and a forward and a rearward right side pair of chains 69b,d: each of said chains being in a fixed attachment at a top and a bottom end to said gantry;

NOTE: other than being positioned at different points in said gantry, all said chains are exactly alike, so a representative drawing 69a(b,c,d) FIG. 8b is presented as representative of all four such climbing chains; said chains are all affixed at a top end and a bottom end in a non-moveable manner to said gantry framework and all will be referred to by the character 69 and an association reference to their location within the gantry; e.g. a left rear climbing chain 69a, a left front climbing chain 69b, a right rear climbing chain 69c or a right front climbing chain 69d.

Said vertical level control assembly further comprising a control handle 47 FIG. 7a/7b, said handle comprising a rod structure which begins as a rear facing horizontally oriented hand grip 47a FIG. 7b following which comes a second section of said handle 47b FIG. 7b comprising a section that is bent away at ninety degrees to said hand grip section, which is affixed at a rearward end of a threaded handle axle bolt 47c FIG. 7b which said handle axle bolt, after a passage through and being stabilized by a rearmost section of a left rear, end bracket 48 FIG. 7b arrangement of said transverse guide rail assembly; is affixed to a smaller power augmentation gear 49 FIG. 7b of a pair of power augmentation gears 49,50 FIG. 7b, with a larger power augmentation gear 50 FIG. 7b, being situated below and in vertical alignment with said smaller gear; said larger gear being affixed near a rear most end of a left side stationary climbing chain sprocket axle 51 FIG. 7b; a rearmost termination of said sprocket axle being situated within a left side vertical level control mechanism toggle lock assembly 52 FIG. 7b which said toggle lock assembly is affixed to a rearmost component of said left rear, end bracket 48 of said transverse guide rail assembly;

an activation of a toggle lock handle 52a FIG. 7b of said toggle lock assembly 52 FIG. 7b of said transverse guide rail assembly leads to a prevention of an upward or downward movement of said climbing chain sprockets and a fixation of said transverse guide rail assembly at any vertical position along a full height of said gantry, a deactivation of said lock assembly 52 FIG. 7b leading to an allowance of an upward or a downward movement of said transverse guide rail assembly along a full height of said gantry;

said pair of power augmentation gears being connected by a continuous loop power augmentation gear drive chain 53 FIG. 7b; said augmentation gears providing a mechanical advantage to a rotational force being applied following an initiation of a rotation of said control handle; and, said drive chain connecting said augmentation gears serving to provide a transfer of a movement created by said rotational force from said control handle to create a rotation of said left climbing chain sprocket axle 51 FIG. 7b;

continuing forward from said augmentation gear 50, said left side climbing chain sprocket axle 51 next enters an attachment to and passes through a left rear stationary chain climbing sprocket 54a FIG. 7c,

NOTE: there are four such stationary chain climbing sprockets (54a,b,c,d FIG. 8b) involved as a part of said vertical level control assembly; other than being positioned at different points in said gantry, all such stationary chain climbing sprockets are exactly alike, so a representative drawing 54a FIG. 7c is presented as representative of all four such climbing chain sprockets;

said sprockets are all in an affixation to one of a pair of climbing chain axles 51 or 552 FIG. 7b; said left side climbing chain axle 51 and a right side climbing chain axle 552 FIG. 7b (only a rear termination of which is visible); all said stationary chain climbing sprockets will be referred to by the character 54 and an association reference to their location within the gantry; e.g. said left rear stationary chain climbing sprocket 54a FIG. 7c being in an affixation on on said climbing chain axle 51; a left front stationary chain climbing sprocket 54b FIG. 7b also being in an affixation on said climbing chain axle 51; a right rear stationary chain climbing sprocket 54c FIG. 7b being in an affixation on said climbing chain axle 552; a right front stationary chain climbing sprocket 54d FIG. 7b also being in an affixation on said climbing chain axle 552 7b (only the end of which is visible, the remainder being in a right lateral position behind said right upper cross brace 14g FIG. 7b. After said passage through said left rear stationary chain climbing sprocket 54a, said axle 51 next passes through a left rear guide bolt bracket 65a FIG. 7b following which it passes forward through a left front guide bolt bracket 65b FIG. 7b and then makes a passage into and said affixation to said left front stationary chain climbing sprocket 54b FIG. 7a; after said passage through said sprocket 54b, said axle 51 passes into and is affixed within a left side cross chain sprocket 57, FIG. 7b, one of a pair of cross chain sprockets, said left side cross chain sprocket 57 and a right side cross chain sprocket 58 FIG. 7b; said axle then ending at a passage through a left front axle end bracket 55a FIG. 7b.

### Cross Chain Assemblage

Said left cross chain sprocket 57 FIG. 7a being connected to said right side cross chain sprocket 58 FIG. 7a by an engagement with a continuous loop cross chain 59 FIG. 7a, said cross chain describing a solid loop around said cross chain sprockets; a top left lateral portion of said cross chain being engaged within an of idler arm tension assembly (best seen in detail as) 64 FIG. 8c (and also seen in relation to said vertical level control assembly 14) as 64 FIG. 8a, said tension arm assembly comprising in part a pair of tension assembly idler wheels 60,61 FIG. 8c, said tension arm idler wheels serving to provide an optimal adjustment of a tension of said cross chain; said idler arm tension assembly 64 comprising a slotted idler arm 62 FIG. 8c projecting rightward from an attachment at a left lateral forward end of said transverse guide rail assembly; a central most idler wheel 61 being held in a fixed position at a central most end of said idler arm by a bolt and nut 61a FIG. 8c; a lateral most idler wheel 60 being held in an adjustable affixation within a horizontal slot 63 FIG. 8c within said idler arm 62 by a nut and bolt 60a FIG. 8c such that said idler pulley can be moved in a leftward or rightward direction within said slot as needed to accomplish an increase or a decrease of tension on said cross chain, said movement being performed in order to create an appropriate tension adjustment of said cross chain; said cross chain making a passage beneath said lateral most idler wheel and over a top of said central most idler wheel.

Said right side cross chain sprocket 58 being affixed near a forward end of said right side stationary climbing chain sprocket axle 552 FIG. 7b, only a rearmost end of which said axle is visible, said axle 552 comes to a front termination just forward of said right side cross chain sprocket 58 FIG. 7b after a passage through a front right sprocket axle end bracket 55b FIG. 7b.

Continuing in a rearward direction from said cross chain sprocket 58, said axle 552 makes a passage through said climbing chain right front 54d, then passes through said right front guide bolt bracket 65d and said right rear guide bolt bracket 65c, passing next though and into an attachment with said right rear climbing chain sprocket 54c and then into a rear termination within a right side vertical level control assembly toggle lock mechanism 68 FIG. 7b; a locking or unlocking of said toggle lock mechanism being afforded by a toggle lock handle 68a FIG. 7ba; said lock mechanism being affixed to said right rear end bracket 66 FIG. 7b. of said transverse guide rail assembly; said lock mechanism 68 serving as one of a pair of locks 52 or 68 FIG. 7b capable of maintaining said vertical level control assembly at a desired level above said floor of said sawmill;

Following a release of said locks 52 or 68 of said vertical level control assembly, a rotation of said left side control handle 47a FIG. 7b serves to cause said attached left side rear end and left side forward end climbing sprockets to rotate and climb in an upward or a downward direction along said stationary vertical climbing chain, with a simultaneous directional and vertical length of travel being imparted to said right side climbing chain sprocket axle and its associated gears, sprockets and associated components by said rotation of said cross chain;

NOTE: as with the stationary climbing chains themselves, other than being positioned at different points in said gantry, all said immediately associated climbing chain sprockets, climbing chain tension pulleys and attachment bolts and nuts are exactly alike, so a representative drawing FIG. 8b is presented as representative of all four such components, and all will be referred to by their character number and an associated lower case letter a,b,c,d with the association reference being to their location within the gantry; e.g. said left rear climbing chain sprocket 69a, left front climbing chain sprocket 69b, right rear climbing chain sprocket 69c or said right front climbing chain sprocket 69d. The associated components, including: the half circle loops 70a,b,c,d; upper idler wheels 71a,b,c,d; lower idler wheels 72a,b,c,d components also representing their positions by the lower case letters indicating like positions in the gantry.

Each of which said stationary chains 69 (a,b,c,d) FIG. 8b are held in an engagement with an associated stationary chain climbing sprocket 54 (a,b,c,d) FIG. 8b, by their being held in an associated one of a series of half circle loops 70 (a,b,c,d) FIG. 8b of said stationary chains by an associated one of a series of pairs of idler wheels and associated mounting bolts 71a,b,c,d and 72 a,b,c,d,72 FIG. 8b; an upper idler wheel and associated mounting bolt 71(a,b,c,d) FIG. 8b and a lower idler wheel and associated mounting bolt 72(a,b,c,d) FIG. 8b; said idler wheels being bolted within said guide bolt brackets such that said idler wheels are in an exact vertical alignment respectively above and below said associated climbing chain sprocket; said idler wheels being adjusted in tension so as to provide an appropriate tension for a maintenance of an engagement between said climbing sprockets and said stationary chains.

### Transverse Guide Rail Assembly

Said transverse guide rail assembly 14 FIG. 7a, which provides said mounting platform upon which said chain saw attachment and positioning assembly can be situated in a stable but removable manner within said gantry; comprises in part a pair of transverse guide rails 140, 141 FIG. 7b, a rear transverse guide rail 140 and a front transverse guide rail 141; said transverse guide rail assembly also partially comprising a set of guide rail support cross members (14g,h,i,j FIG. 7b);

a lower pair of which said longitudinal guide rail support cross members 14 h,14j FIG. 7b, a lower left side guide rail cross member 14j and a lower right side guide rail cross member 14h, are in a positional situation respectively beneath and at a left end and a right end of said transverse guide rails 140,141 to which said guide rails said lower guide rail support cross members are in a removable affixation by a set of U-bolt connectors 18a,18b,18c 18d FIG. 7d; a left rear guide rail U-bolt connector 18a FIG. 7d, a left front guide rail U-bolt connector 18b FIG. 7d, a right rear guide rail U-bolt connector 18c FIG. 7d and a right front guide rail U-bolt connector 18d. FIG. 7d. Upper right side guide rail cross member 14g is in a front end attachment to an inner aspect of bracket 65d FIG. 7b and in a rear end attachment to an inner aspect of bracket 65c FIG. 7b. Although not visible in the illustration, an exact same attachment via a set of connector brackets 65 a/b/c/d FIG. 7b exists for a front end of upper cross member 14i to bracket 65b and for a rear end of cross member 14i to bracket 65a. Upper cross members 14g and 14i serving as further cross bracing for connector brackets 65a,b,c,d.

Lower guide rail cross members 14h,14j are held in a removable attachment to brackets 65a,b,c,d by a set of four pairs of O.C. tube attachment bolts 9 FIG. 7d—only two pairs of which, a right front and a right rear pair, are visible—, a head of each of the bolts 9 FIG. 7d is in a location in an appropriate O.C. tube; a threaded end of each bolt 9 FIG. 7d is in a projection through an appropriate brackets 65a,b,c,d FIG. 7b such that with a tightening of a nut situated on the threaded end of each of said bolts, a solid affixation of cross members 14h or 14j against said appropriate bracket 65a,b,c,d FIG. 7b is afforded; thus serving to provide a stabilization of the transverse guide rails 140,141 within the transverse guiderail apparatus of the gantry and in an appropriate association with the vertical level control mechanism components of the sawmill apparatus. Note: since all of a series of attachments of both cross members 14h and 14j to said guide bolt brackets 65 a,b,c,d are identical, the one example given is presented as a representation of each of said connections.

Said upper guide rail support cross members 14g and 14i FIG. 7b are in a permanent affixation on a central facing aspect of said set of guide bolt brackets 65a,b,c,d FIG. 7b;

each of said set of brackets 65a,b,c,d FIG. 7b further comprising a vertical plate portion in a situation along side an O.C. tube opening of said O.C. tubes 14a,b,c,d FIG. 7b; said O.C. tubes 14a,b,c,d each being held in a moveable affixation with an associated guide bolt bracket 65a,b,c,d by a set of four pairs of transverse guide rail vertical travel-guide nut and bolt sets, which said pairs are typified by a left rear top transverse guide rail vertical travel-guide nut and bolt set 14k FIG. 7c, and a left rear bottom transverse guide rail vertical travel-guide nut and bolt set is not visible 14m FIG. 7c; said other three sets of such pairs of transverse guide rail vertical travel-guide nut and bolt sets are not visible, however they are located within an analogous bracket and O.C. tube arrangement with said gantry main frame O.C. tubes 14,a,b,c,d, which said O.C tubes as described prior are in said affixation with an associated set of said gantry vertical frame members 510a,b,c,d. FIG. 5c.

These other three sets of vertical travel guide nuts and bolts and a nature of their engagement within the relationship of the climbing chain assembly, the transverse guide rail assembly and the gantry are not described in detail because they are physically and functionally mirror images of the arrangement just described for bolt and nut sets 14k,14m, hence the description of said bolt and nut sets 14k and 14m are presented as a representative example of all such pairings.

Said transverse guide rails, guide rail support cross members and associated support brackets forming thus a rectilinear cross framework at said right and said left ends of said transverse carriage guide rails; said rectilinear cross framework serving as a support framework within which said stationary chain vertical level control climbing sprocket axles of said carriage vertical level control assembly are situated.

A head of each of bolts of said nut and bolt sets 14k, 14m FIG. 7c, which are in an association within a slot in said O.C. tube 14c, act in a concerted manner with their analogs (not visible) that are in a like relational association with O.C. tubes 14b,14c,14d FIG. 7b, thus serving to act as a set of guides of a vertical movement of said transverse guide rail assembly in said upward or downward direction within said gantry under the motive power provided by said stationary chain vertical level control assembly 14 FIG. 7a.

### Conversion for Adaptation for Use on Other Sawmill Frameworks

It is an object of this invention to provide a combined, modified chainsaw transverse guide rail and chainsaw carriage assembly that allows a use of this modified combination device within an existing sawmill apparatus other than that of the present invention, said existing sawmill having a pair of longitudinal carriage support rails. A conversion and modification adapter kit is necessary for a provision allowing of said use; said adaptor kit in essence comprising a wheel adaptor conversion kit.

A first step involved in allowing said use in other sawmills involves: a disconnection of a removable section of said transverse guide rail assembly 650 FIG. 7d; said removal being allowed by a loosening of the heads of the four paired sets of OC tube attachment bolts 9 FIG. 7d, which said loosening allows an intact removal of said removable guide rail section 650 FIG. 7d from the gantry.

A conversion modification adaptation is then needed in order to create a pair of wheel assemblies 180 FIGS. 7e and 181 FIG. 7e, which said wheel assemblies will afford an ability for a mounting of the sawmill carriage device of this invention on the longitudinal guide rail saw supports of many sawmill apparatuses.

A right side wheel adaptor conversion plate 18g is seen in FIG. 7f. A left side wheel adaptor conversion plate 18f FIG. 7e is not shown in detail, however it is a mirror image of conversion plate 18g FIG. 7f, so only the latter will be described in detail; the attachment parts associated with each of these said connector plates being exactly the same.

In FIG. 7f, it is seen that there is a front end set of attachment components 18h,i,j,k,l,m,n,o,p FIG. 7b; a mirror image set comprising a rear end set of attachment components is shown as 18q-y FIG. 7f. Since the components of both sets are exactly the same it is not deemed necessary to describe the rear end set separately; a mirror image situation exists at the left side wheel adaptor conversion plate, so that array will not be described in detail and a description of the right side front end conversion plate attachment group will serve as a description for all such.

A wheel axle bolt 18h FIG. 7f passes through an axle wheel bolt hole 18i in conversion plate 18g, following which the bolt passes through a washer 18j then a spacer hub 18k and next through a grooved wheel 181 and finally into a nut 18m, which nut 18m, when tightened onto bolt 18h serves to hold wheel 181 affixed to the conversion bar 18g. A pair of O.C. tube connector bolts 18n pass though a pair of O.C. tube connector bolt holes 18o in conversion plate 18g and then into a pair of O.C tube connector bolt nuts 18p.

Once all four groups of attachment components shown as 18h-18p FIG. 7f are situated in their appropriate positions on said adaptor conversion plates 18f and 18g, a tightening of the heads of the O.C. tube connector bolts 18n provides an affixation of the wheel assemblies 180, 181 FIG. 7e into the associated O.C. tubes. The U-bolt connections 18a,b,c,d of O.C. tubes 14h and 14j FIG. 7d serve to connect the wheel assemblies which are in an association with the wheel adaptor conversion plates 18f, 18g FIG. 7e to the transverse guide rails 140, 141 FIG. 7e, thus completing the conversion necessary for a use of the saw carriage of this invention within many other sawmill apparatuses.

### Chainsaw Carriage Assembly

Said chain saw carriage assembly 100a FIG. 1a comprising in part, a chainsaw attachment component 3 FIG. 1a, and a saw blade orientation component (1 plus 2 FIG. 1a) which said saw blade orientation component comprises in part a body assembly section 1 FIG. 1a and a lockable, hinged saw blade orientation assembly 2 FIG. 1a component, which said hinged orientation assembly acts as a saw blade orientation means allowing of a change between and a stable maintenance of either of a perpendicular or a horizontal planar attitude of a blade of said chain saw with said saw blade oriented in a longitudinal cutting alignment;

### Body Section of Saw Blade Orientation Component

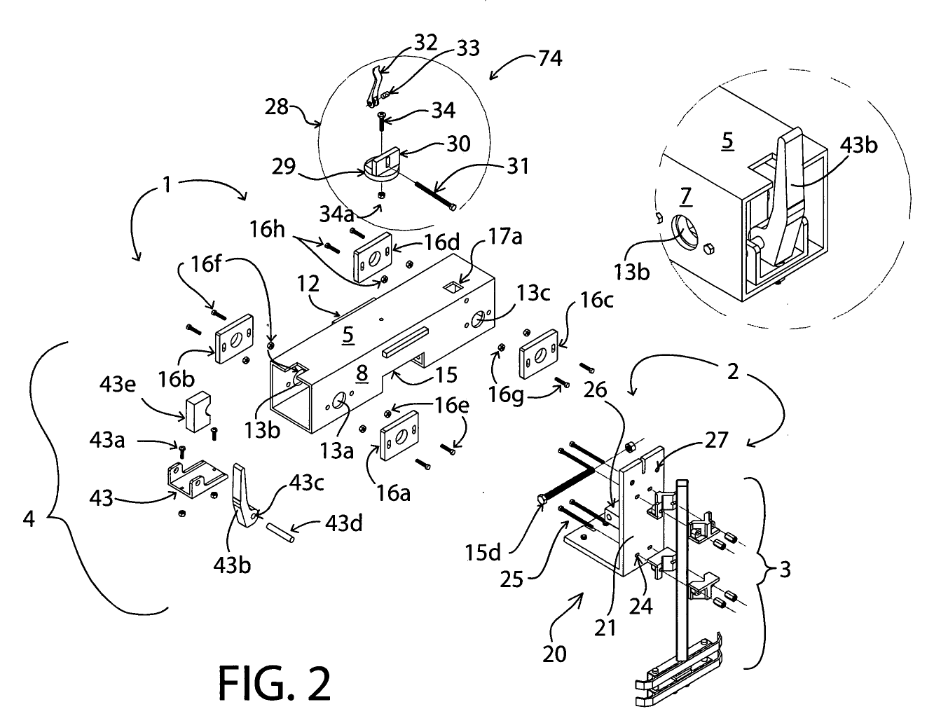

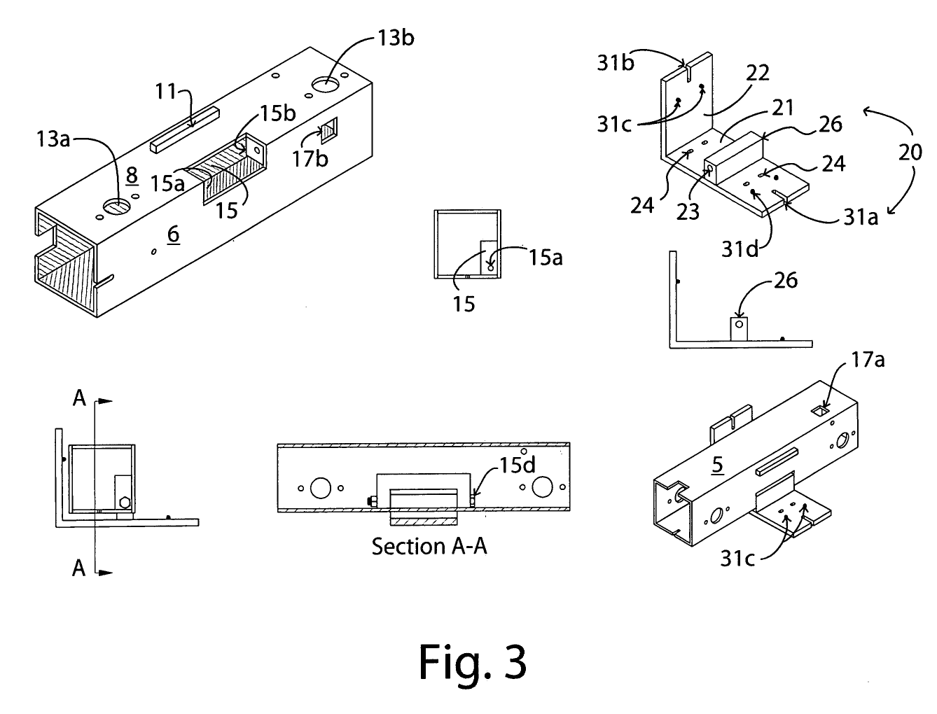

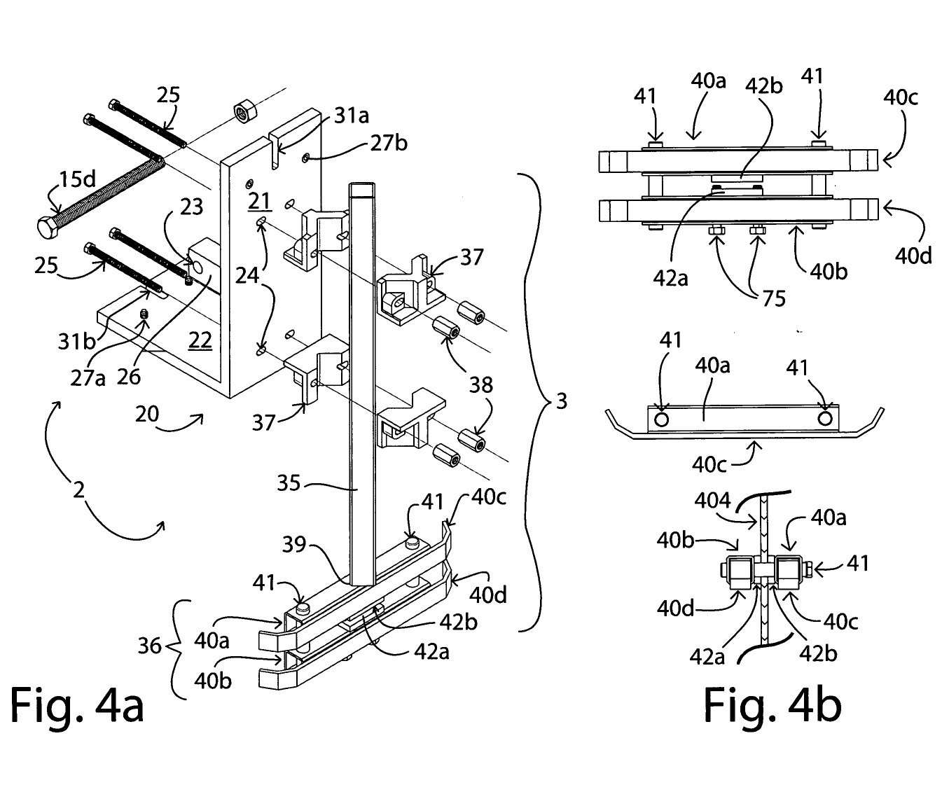

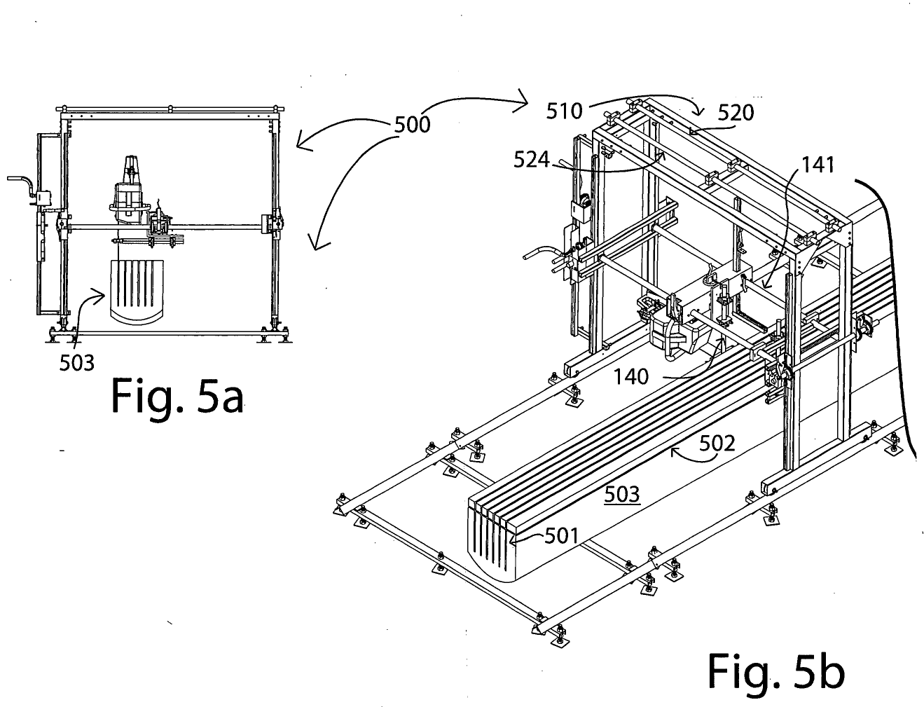

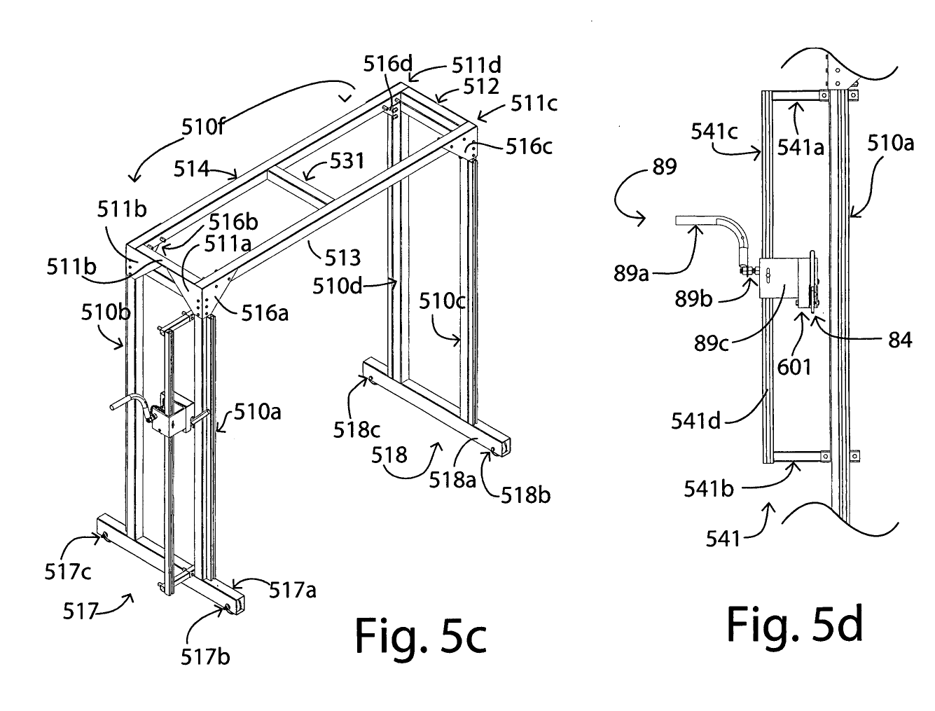

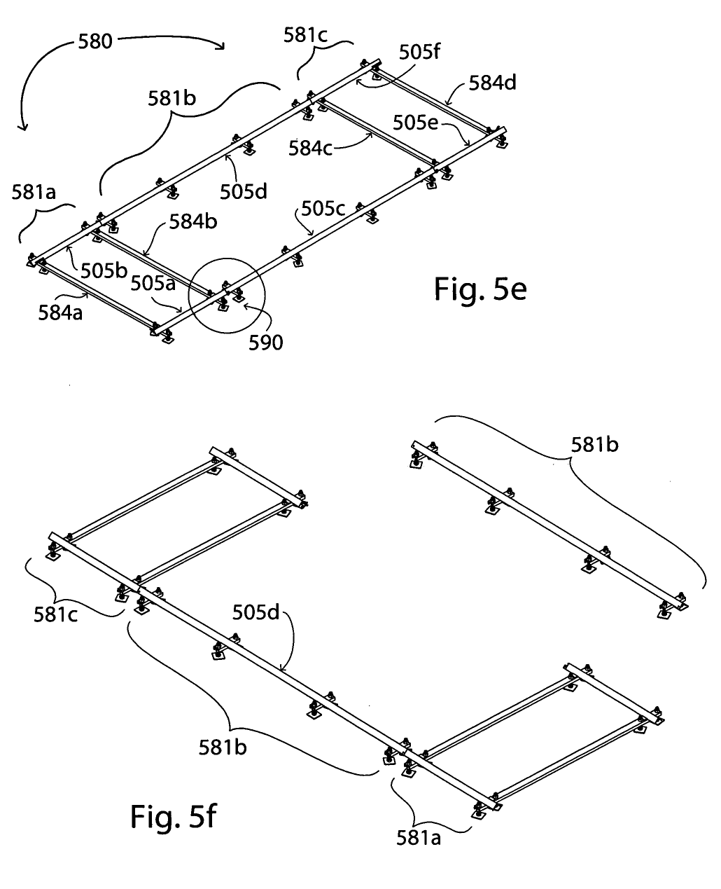

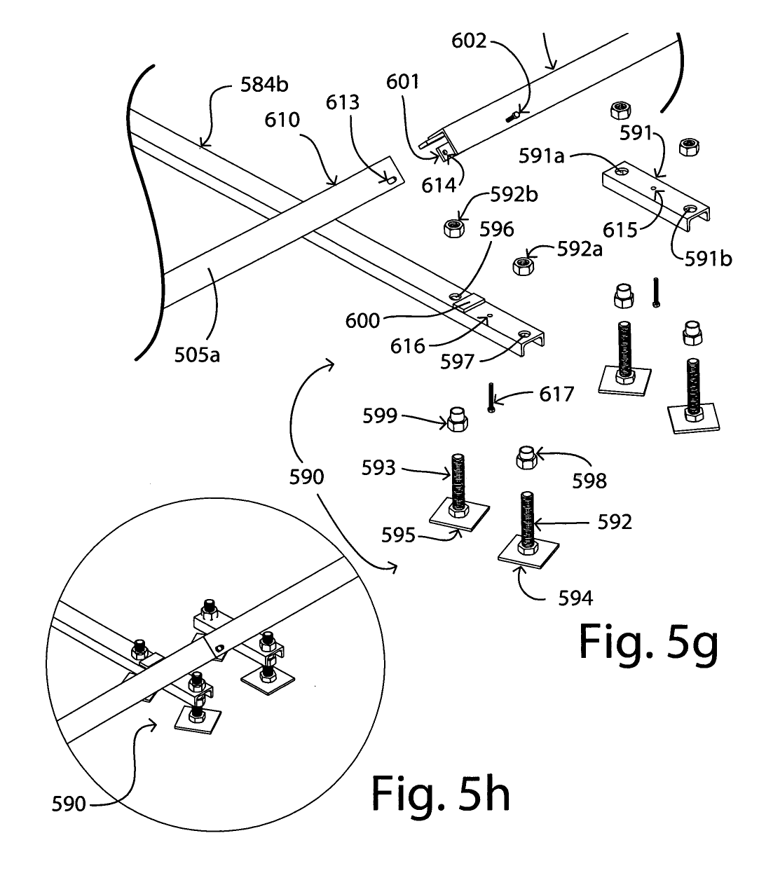

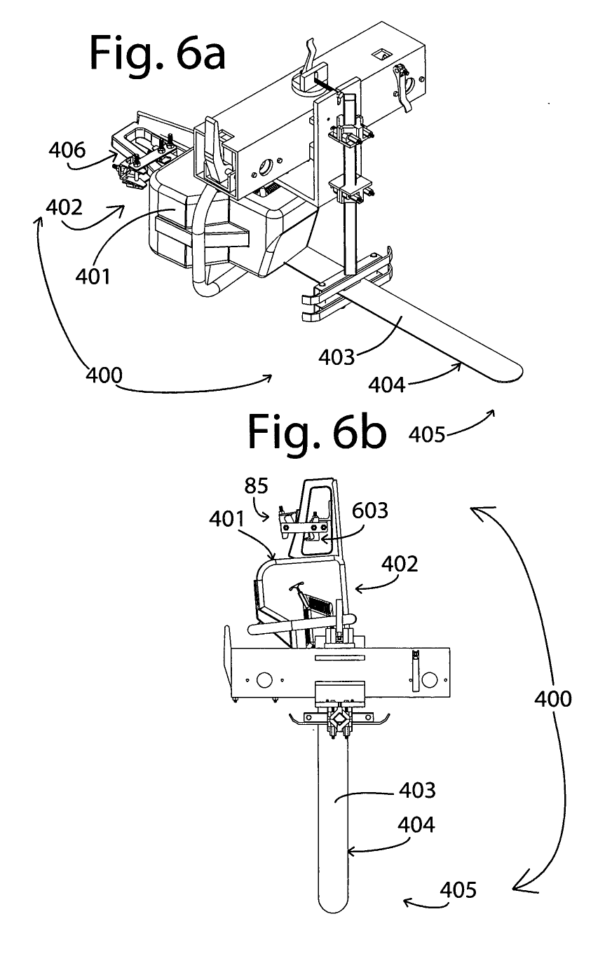

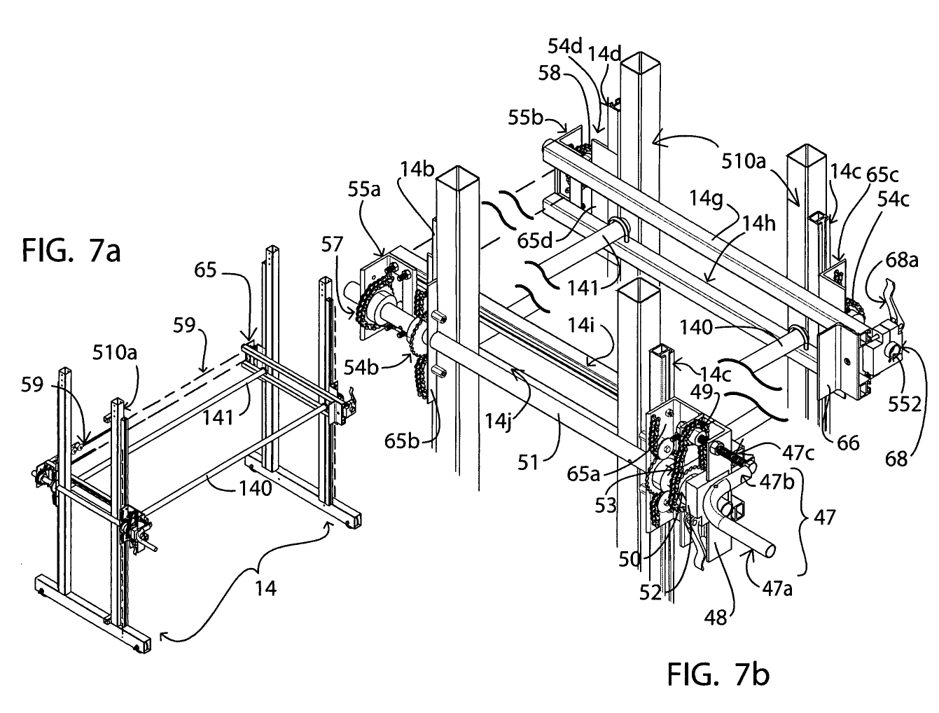

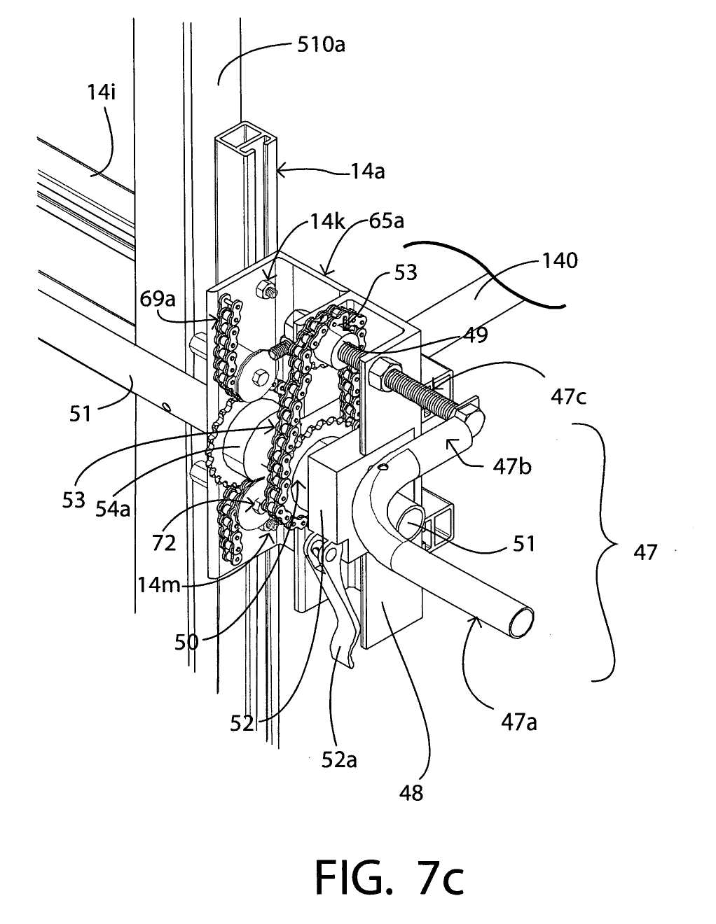

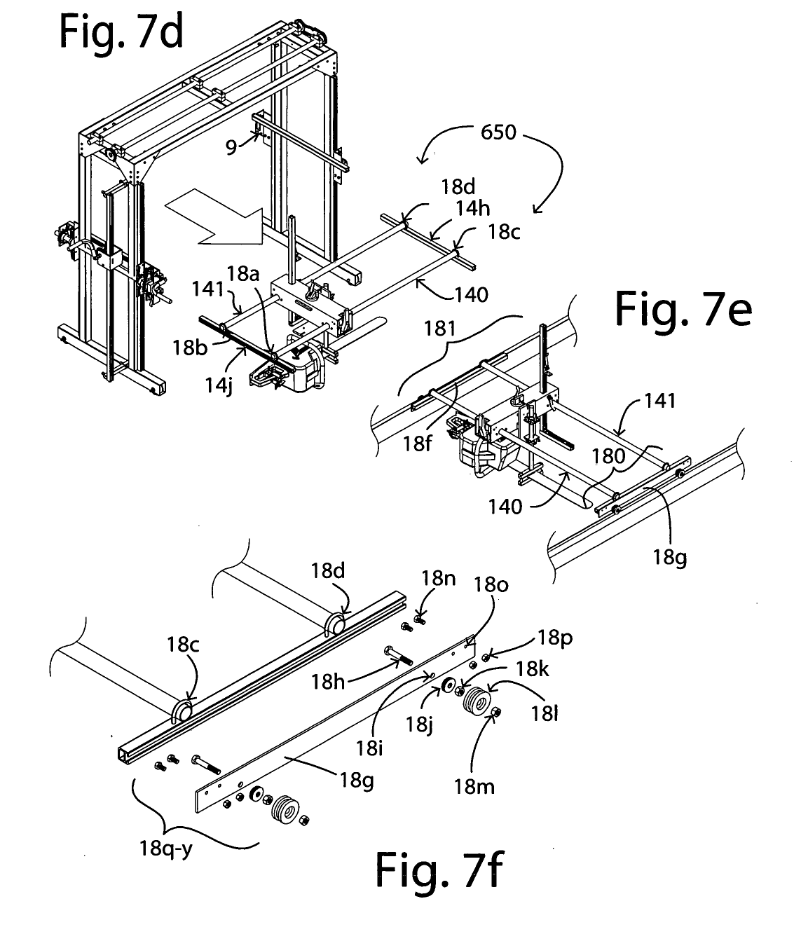

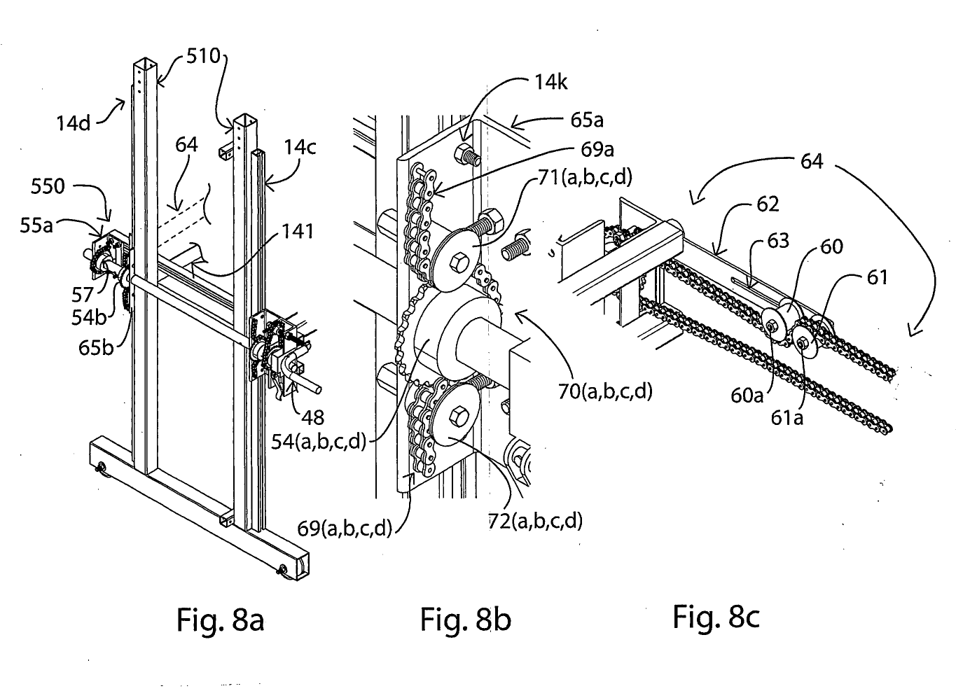

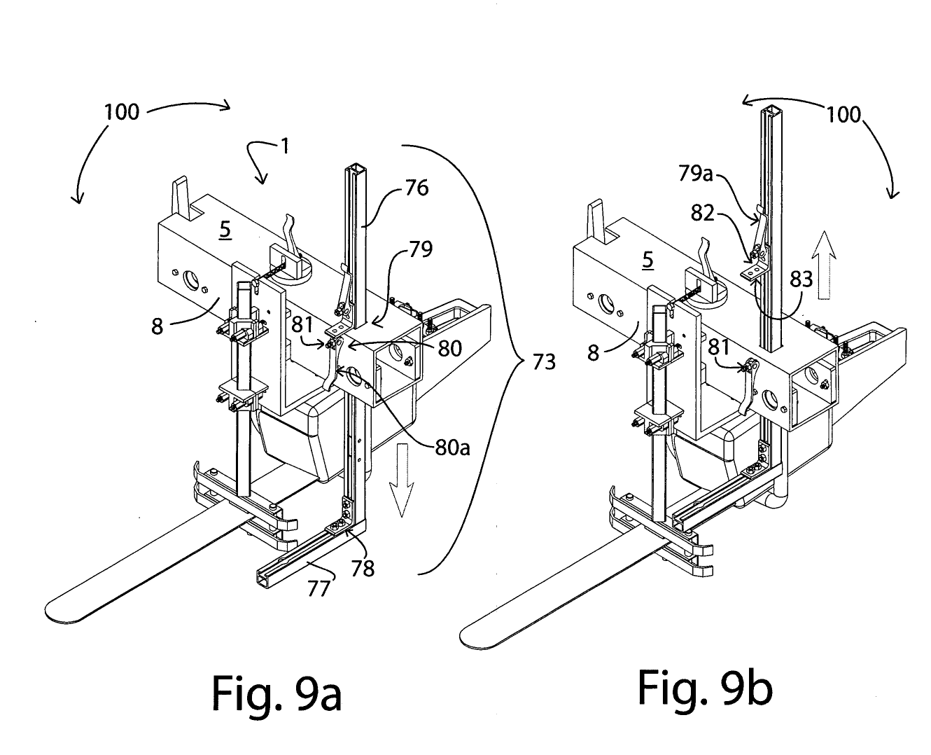

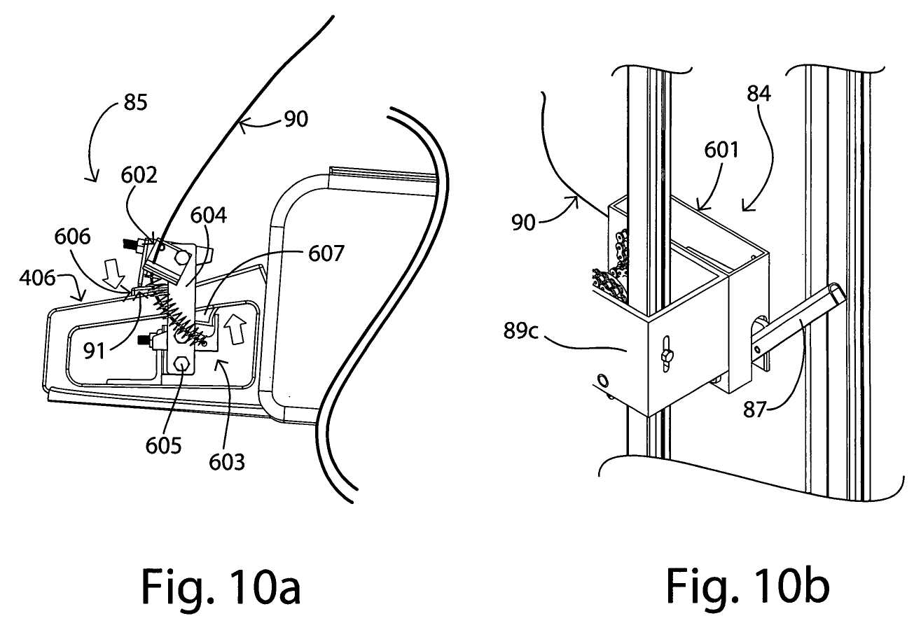

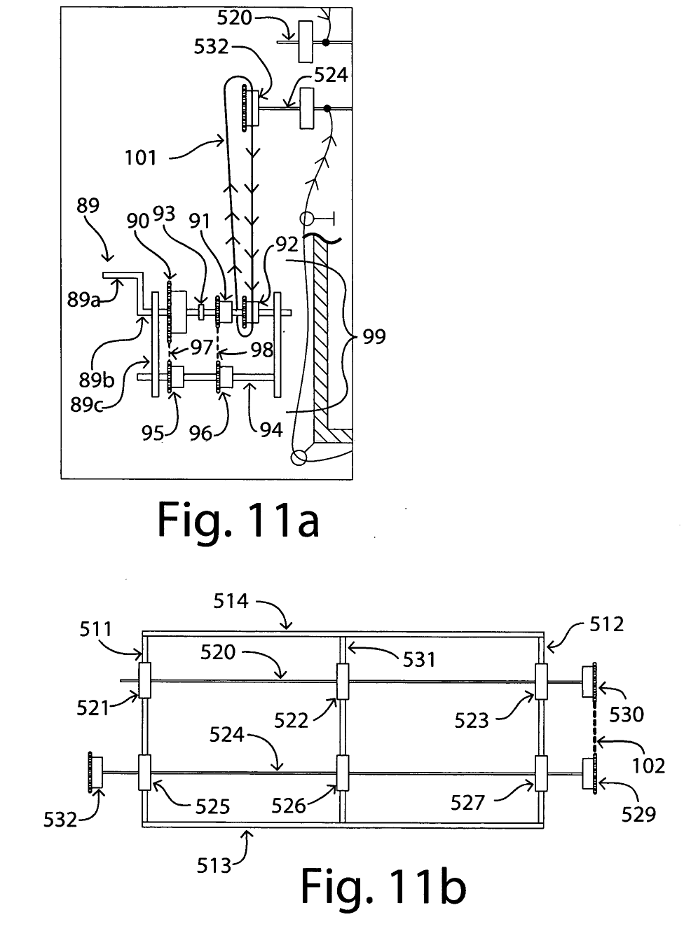

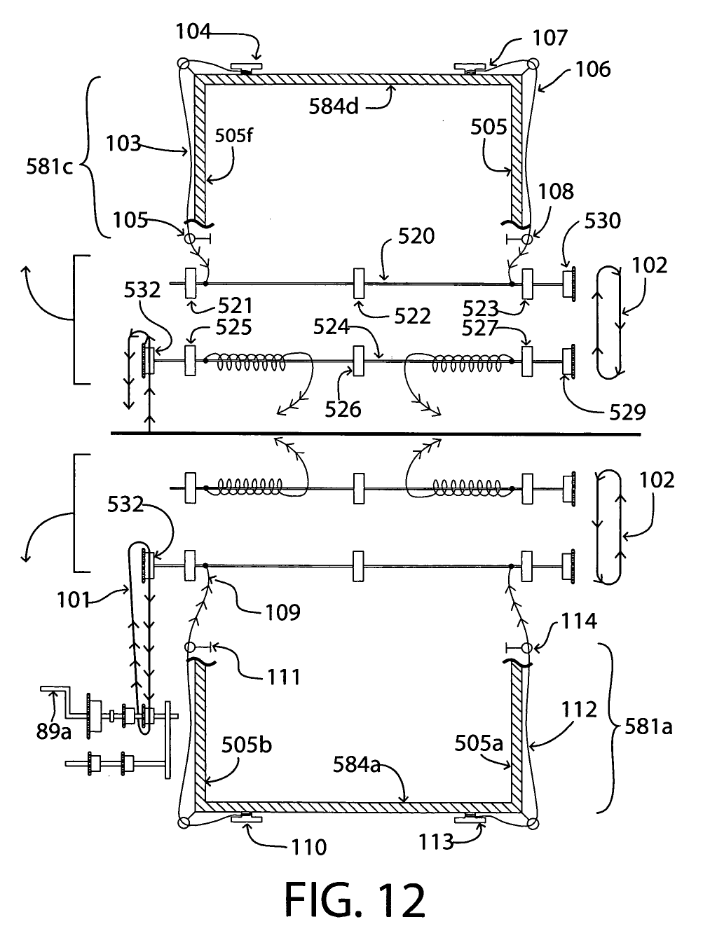

A body assembly section 1 FIG. 1a comprises in part an elongated, parallelepiped shaped body member 5,7,8 FIG. 2 plus 6 FIG. 3. Said body member further comprising in part a top plate 5 FIG. 2, a bottom plate 6 FIG. 3, a left side plate 7 FIG. 1b, a right side plate 8 FIG. 2

A set of circular transverse guide rail openings 13a,13c,13 b are seen in FIG. 2; a pair of guide rail openings 13a and 13c are in a location on said right side plate 8 and a rear left guide rail openings 13b is seen in a location on said left side plate 7; a left side front guide rail opening is not visible, however said opening is in a like position of said left side plate 7 as is said opening 13c on said side plate 8.

Each of these guide rail openings is in an internally facing attachment with an associated guide rail bushing plate 16a,16b,16c,16d FIG. 2, with each of said bushing plates being in an affixation to an inner aspect of an associated side plate by an associated pair of bushing plate nuts and bolts 16e,16f,16g,16h. NOTE: for purposes of clarity, the bushings 16a/b/c/d and the associated nuts and bolts 16e/f/g/h are shown external to the body member 5,7,8 FIG. 2 plus 6 FIG. 3, while in actuality, the bushing plates are mounted internally within said body section.

Said bushing plates providing a gliding surface for said Transverse guide rails 140, 141 FIG. 7a of said transverse guide rail assembly as said guide rails pass through the guide rail holes 13a,b,c,d of said body section 1a of said chainsaw carriage assembly 100a FIG. 1; thus creating a laterally moveable affixation of said carriage within said gantry and allowing of a range of movement of said carriage assembly across a full left to right width of said gantry of said sawmill apparatus and allowing an improved ability to accurately create a series of dimensional pieces of lumber with said parent log being left in said original, unturned position.

Said body section further comprising in part a right side hinge plate spacer ridge 11 FIG. 2 and a left side hinge plate spacer ridge 12 FIG. 2,

said body section further comprising a chain saw attachment assembly receiver cutout 15 FIG. 3 located beneath said right side spacer ridge near a bottom edge of said right side plate 8, said receiver cutout 15 being pierced at a front and a rear face by a pair of hinge attachment axle bolt receiver holes 15a,b FIG. 3, only the front face hole 15b of said pair of holes is visible.; said axle bolt receiver holes being designed for a passage of a hinge attachment axle bolt 15d FIG. 4a;

said body section further comprising a pair of opposed depth gauge openings 17a, 17b FIG. 3 said openings being situated near said front end of said top and said bottom plates of said saw attachment and positioning assembly allowing for a placement of a removable horizontal cut thickness gauge 73 FIG. 9a, said gauge capable of being set in a manner providing a preferred thickness of cut in a series of repeated cutting passes through said log or other chainsaw cuttable substrate; this gauge will be described in greater detail later.

### Hinged Saw Blade Orientation Assembly of Saw Blade Orientation Component

A hinged saw blade orientation assembly 2 FIG. 2 comprising in part an L shaped hinge frame 20 FIG. 2 which said hinge frame comprises in part a pair of side elements 21,22 FIG. 3, a longer side element 21 FIG. 3 and a shorter side element 22 FIG. 3, said side elements being arranged in a permanent junction at a 90 degree angle one to the other;

a swivel lock bolt slot 31a FIG. 3 is located at a top edge of said longer side element 21 and a swivel lock bolt slot 31b FIG. 3 is located at a top edge of said shorter side element 22; said longer side element being pierced as well by a series of four hinge plate attachment holes 24 FIG. 3 for receiving a set of four hinge plate attachment bolts 25 FIG. 4a and nuts 38 FIG. 4a for attaching said chainsaw attachment component 3 FIG. 4a to said hinge plate assembly;

said hinged attachment plate 20 FIG. 3 also partially comprising an internally facing hinge axle block 26 FIG. 3, said block being pierced by a hinge axle block bolt hole 23 FIG. 3 designed to receive said hinge attachment axle bolt 15d FIG. 4a; said axle bolt allowing of a rotatable, moveable affixation of said longer side element 21 FIG. 3 to a side of said body of said carriage when said hinge axle block is situated within said body's said attachment assembly receiver cutout 15 FIG. 3 and said axle bolt is inserted;

said hinge plate assembly also comprising a hinge-swivel lock component 74 FIG. 2, said swivel lock component being in a situation in a rotatable affixation to said top plate of said body section of said chainsaw attachment and positioning assembly by a swivel lock axle bolt and nut set 34,34a FIG. 2, said swivel lock component further comprising a swivel lock body base 29 FIG. 2, a slotted swivel lock bolt plate 30 FIG. 2, a swivel lock plate bolt 31 FIG. 2 and a swivel lock locking handle 32 FIG. 2, said handle containing a captured cylindrical nut 33 FIG. 2 to receive said swivel lockplate bolt 31; said chain saw blade being held in a stably maintainable attitude within either a horizontal or a vertical plane of orientation of said saw blade by an engagement and locking of said swivel lock bolt within, respectively, said lock bolt slot of said longer or of said shorter L shaped section of said hinge frame;

the whole being arranged such that a release of said swivel lock locking handle allows a removal of said swivel lock bolt from an engagement within said swivel lock bolt slot located in a side element of said L shaped frame of said hinge plate assembly, allowing thus a selectable alternation of a planar attitude of said saw blade of said chain saw between a perpendicular or a horizontal alignment of said blade of said chain saw., and a creation of successive pieces of dimensional lumber while leaving a parent log in an unturned, original position within said sawmill.

### Hinge Alignment Fine Tuning Assembly

a hinge alignment fine tuning assembly of said saw blade orientation component comprises in part a set of two pairs of hinge alignment fine tuning set screws 31c, 31d FIG. 3; a pair of set screws 31c in said shorter side element 22 of said L shaped hinge frame, and a pair of set screws 31d in said longer side element 21 of said L shaped hinge frame

said set screws being situated in either one of a pair of two pairs of threaded set screw holes 27a and 27b FIG. 4a, said set screw holes being situated in a position within and beneath a top edge of said longer side element and said shorter side element respectively; prior to a tightening of a hinge frame toggle bolt into place within said slots in either side plate of said hinge frame of said body section; either of said pairs of said set screws, depending upon an existing vertical or a horizontal orientation of said saw blade, being capable of an adjustment such that an internal end of an involved pair of said set screws is brought to a rest against an outer aspect of a side plate of said body section of said chainsaw attachment and positioning assembly; an inward or an outward movement adjustment of one pair of said set screws against said side wall leading to an alteration of a vertical or a horizontal alignment of said hinge plate, which said hinge plate adjustment creates an alteration of a vertical or a horizontal alignment of said saw blade through an alteration of a vertical or a horizontal alignment of a bar clamp connector arm 35, FIG. 4a of said chainsaw attachment component 3 FIG. 2; following said fine tuning adjustment, said hinge lock bolt is locked into place; said fine tuning assembly thus allowing of an adjustment of said chainsaw blade 404 FIG. 6a towards a truer perpendicular or horizontal planar orientation; allowing thus of an accurate creation of successive pieces of orthogonal dimensional lumber.

### Chainsaw Attachment Component

A chainsaw attachment component 2 FIG. 2 of said carriage assembly 100a FIG. 1a comprising in part a bar clamp connector arm 35 FIG. 4a, which said bar clamp connector arm 35 terminates at a lower end by an attachment to a bar clamp component 36 FIG. 4a;

said bar clamp assembly component 36 of said chain saw attachment component being held at an adjustable distance beneath said longer side plate of said hinge frame assembly by a welded affixation at a lower, terminal end 39 FIG. 4a of said bar clamp connector arm 35; an upper end of said bar clamp connector arm being in a moveable affixation above to said longer side element of said L shaped hinge frame by an affixation within a pair of bar clamp connector arm brackets 37 FIG. 4a, said brackets affixing said connector arm 35 to said longer side plate of said hinged saw blade orientation assembly by a set of four bar clamp connector arm attachment bolts/nuts 25 FIG. 4a/38 FIG. 4a;

said bar clamping assembly further comprising in part a pair of inverted U shaped bar clamp body sections (40a,40b FIG. 4a), an upper bar clamp body section 40a FIG. 4a and a lower bar clamp body section 40b FIG. 4a, which said body sections are joined by a pair of bar clamp body bolt, spacer and nut sets 41 FIG. 4a which said nut and bolt sets are situated near a front and a rear extremity of said bar clamp body sections; said conjoined body sections otherwise having an open space between their adjacent sides, said space being for a purpose of allowing a passage of said bar of said chain saw between said bar clamp body sections; an upper section of which said body section 40a FIG. 4a is welded above to said bottom end 39 FIG. 4a of said riser bar clamp connector arm 35; a bottom end of said bar clamp body sections 40a,b, being in a welded affixation below to a pair of foot plate components 40c, 40d FIG. 4a; said foot plate components being welded to said body sections in such manner that a space exists for an insertion of said chainsaw bar between said foot plates;

a pair of chainsaw bar clamping plates 42a,b; an upper bar clamping plate 42a FIG. 4a and a lower bar clamping plate 42b FIG. 4 FIG. 4a are in a situation and affixation in an opposed manner between said upper and lower bar clamp body sections such that a tightening of a pair of clamping plate adjustment bolts 75 FIG. 4b selectively affords a holding of said chain saw bar firmly within said bar clamp assembly, and conversely a release of said bolts releases said bar and allows a withdrawal of said chain saw from said chain saw attachment assembly;

said bases of said foot plates comprise a skid assembly; which said skid assembly would be situated in a manner with a bottom aspect of said foot plates resting against a side surface of the log to be cut when said chainsaw blade is in an orientation for making a through cut in said horizontal cutting plane;

### Secondary Bar Nose End Clamping Assembly

NOTE: optionally, a secondary bar nose end clamping assembly of a same design as said bar nose end vertical cut stabilization component (36 FIG. 4a, best seen in FIG. 4b) can be used for a stabilization of said saw bar nose end of said saw blade bar when cutting at a partial depth into a log using only a bar nose end section of said blade; or, alternatively can serve a use when making horizontally aligned through cuts in a log of an extreme girth wherein a bar nose end stabilization of an extra long saw blade must be used.

Said secondary bar clamping assembly is not described in detail because said assembly comprises exactly a same set of components and arrangement of parts as did the chainsaw bar clamping assembly 36 FIG. 4a described immediately prior. The description of the chainsaw bar clamping assembly 36 FIG. 4a being held to serve as a description of a secondary bar clamping assembly.

The further out towards said nose end of said saw blade said blade is in cutting contact with said log, the greater a tendency of said blade to vibrate and wander from a straight cutting path; this can significantly decrease the accuracy of cutting, and lead to defects such as “scoring” caused by sawbar vibration; processing a rough board to a finished commercial size can result in up to thirty percent waste. Any reduction in defects or increase in accuracy is proportionately rewarded with economic and ecological benefits.

Accordingly, said bar nose end clamping assembly by a provision of a stabilizing support of a blade tip when cutting at a depth using only a bar nose end section of the blade; provides both a reduction of sawing waste and a prevention of a downward movement of said saw blade nose end otherwise associated with a downward pull of said saw blade that otherwise might draw the blade deeper than intended; the bar nose end clamping assembly thus preventing a fluctuation of depth of cut along a length of a piece of dimensional lumber created in said sawmill apparatus.

Said adjustable bar nose end clamping assembly can be placed in a firm affixation to said saw bar at an appropriate location along a length of said saw bar, then, as needed, released by a loosening of said clamping plate adjustment bolts 75 FIG. 4b and removed or alternatively repositioned at a next appropriate level along said saw bar.

### Lateral Position Locking Assembly of Body Section

A locking of an integral lateral positioning locking assembly mechanism 4 FIG. 2 of said body component 1 FIG. 2 allows of a fixation of said carriage in a stably situated, fixed, but alterable manner at any point along said transverse guide rails 140,141 FIG. 7b; an unlocking of said integral lateral positioning locking mechanism making possible a movement of said chainsaw carriage assembly in either a left or a right direction along a full length of said rails of said transverse guide rail assembly of said sawmill, thus allowing a making of multiple vertically oriented cuts at a desired separation across a full width of said log, cant or other substrate as part of a process of allowing of an accurate creation of successive pieces of dimensional lumber;

said lateral positioning locking assembly 4 FIG. 2 comprises in part a lateral lock assembly base plate 43 FIG. 2, a base of which is pierced by a pair of screw holes and partially surmounted by a pair of rear end partial side walls, each of which side walls bear an axle pin slot near a top level; said lock assembly base plate being affixable within a rear floor section of said body assembly 1 FIG. 2 by a pair of lock assembly base plate attachment screws 43a FIG. 2;

said locking assembly further comprising a lock handle arm terminating inferiorly in a cam shaped end 43b FIG. 2, said cam shaped end of said handle being pierced through from left to right by an axle pin hole 43c FIG. 2, said axle pin hole designed for a receiving of a lateral positioning lock assembly axle pin 43d FIG. 2;

with said body section mounted on said transverse guide rail assembly with guide rails 140,141 FIG. 7b situated within said body section guide rail holes 13a,b,c,d FIG. 2, said base plate is placed into an affixation within said body section by said screws 43a, following which a lateral locking assembly lock block 43e FIG. 2, which said lock block bears a front end concavity conformed to the same arc of curvature as an external wall of said transverse guide assembly guide rails 140,141 FIG. 7a, is situated in a position atop a forward end of said top surface of said base plate 43, following which said handle 43b is affixed in a rearmost position atop said base plate by said axle pin 43d.

Following these preparations, a forward engagement of said lock arm 43b will provide a rotation of said cam end into a compression against said lock block 43e, said front end concavity of said lock block thus being brought into a compression against said rear guide rail 140 FIG. 7a, and thus serving to effect a locking in place of said carriage assembly on said transverse guide rail assembly within said gantry.

A retraction, via a back tilting of said handle 43b down and back to a horizontal position allowing of a disengagement of said lock block from said transverse guide rail creating a release of said lock mechanism and allowing of a free movement of said carriage section in either a right or a left direction along a full width of said transverse guide rails of said gantry of said sawmill apparatus,

said lateral positioning locking assembly thus allowing of a precise controlling of a left side to a right side positioning of said saw blade relative to a left to right width of said gantry while said chainsaw is in said tip down, perpendicular orientation, as well as allowing of a precise controlling of said left side to right side positioning of said saw bar nose end at a selected distance from said right side within said left to right width of said gantry when said chain saw is in said horizontal plane of blade orientation.

### Horizontal Cut Thickness Gauge

Said saw carriage further comprising said removable, horizontal cut thickness gauge assembly 73 FIG. 9a, which said gauge assembly allows of a making of a series of multiple horizontal cuts at an automatically predetermined thickness of cut throughout a full or a partial vertical height of said log or said cant, resulting in an elimination of time spent in re-measurements and a reduction of measurement error in a successive cutting of pieces of dimensional lumber; said horizontal cut thickness gauge assembly, best seen in FIG. 9, comprises in part, an L shaped member 76,77,78 FIG. 9, said L shape member comprising a pair of rectangular O.C. tube elements, a longer, vertical element 76 FIG. 9 having an O.C. tube opening facing a front aspect of said L shape element and a shorter horizontal element 77 FIG. 9 having an O.C. tube opening facing upwards; said horizontal element 77 comprising a foot section of said gauge assembly; said elements being joined by a combination of a thickness gauge frame set of nuts, bolts and a corner brace 78 FIG. 9 so as to form said L shape;

said horizontal cut thickness gauge assembly also comprising a pair of toggle clamp locking assemblies 79,80 FIG. 9, an upper toggle clamp lock assembly 79 and a lower toggle clamp lock assembly 80;

said lower lock assembly 80 comprises a lower lock handle 80a, and a lower lock handle lock bolt and nut set 81 FIG. 9, only a threaded end of said bolt and the nut of said nut and bolt set are visible, a head of said bolt being invisible within a section of said vertical a element O.C. tube section 76 FIG. 9a within said body section 1;

said upper lock assembly 79 comprises an upper lock assembly lock handle 79a FIG. 9b, an upper lock assembly lock bolt 82 FIG. 9b and a corner brace 83 FIG. 9b; said corner brace, and a threaded end of said bolt and the nut of said nut and bolt set are visible, a head of said bolt being invisible within said vertical element 76 FIG. 9.

in an operation of assembly of said horizontal cut thickness gauge within said body section 1 FIG. 9a:

with said vertical level control of said gantry elevated to an adequate level above said log in said sawmill apparatus, following a removal of said upper toggle lock element from said L shape element, a passage of a top end of said vertical element is allowed in a passage from below to above through said lower thickness gauge opening 17b in said bottom plate 6 FIG. 3; said lower toggle lock bolt having been left in a permanent situation on said right side plate of said body said upwards passage of said vertical gauge element now will also allow of a passage of said head of said lower lock toggle bolt into the O.C. tube slot of said vertical section 76 FIG. 9a;

said vertical element continuing upward makes a passage through said upper thickness gauge opening 17a in said top plate 5 FIG. 1a of said carriage body section 1 FIG. 1a; following which said gauge will be in a position with said foot section projecting laterally over said log;

then, following a locking of said lower gauge lock 80 FIG. 9a, which creates a compression of said bolt head laterally towards an inner side aspect of said sidewall of said body section, leading to a stable fixation of said gauge at a selectable height within said body section by a fixation of said vertical element against of said right sidewall 8 of said saw positioning assembly, thereby holding said horizontal cut gauge assembly with said foot of said gauge assembly fixed at a selected horizontal level between the then position of said base 6 FIG. 3 of said saw positioning assembly and a top of said log or other chain saw cuttable substrate;

initially, said affixation is performed with a holding of said gauge in a fixed position relative to said right side plate 8 FIG. 9 such that said foot section is held at an elevation slightly above and projecting laterally over a top level of a log in said mill apparatus;

said upper toggle clamp assembly 79 is kept in a fully assembled state with said bolt and nut passing though and holding said corner brace and lock handle together whether said lock mechanism is in a location within or a location removed from said gauge;

in said process of assembly of said gauge for a use in said mill, said bolt 82 is guided to a passage downward through said O.C. tube slot of said vertical gauge element and then said upper lock element is brought into a locked state with said gauge being held in a position considerably above said body of said carriage component;

In an operation of use of a fully assembled depth gauge in position in said body section:

with said gauge assembly inserted in place, and said lower toggle locking said gauge assembly at an appropriate distance above said log, and said upper toggle assembly being situated well upwards along said vertical element of said gauge assembly; and, following a making of a cant or at least one horizontal top cut in a log;

said transverse guide rail assembly of said gantry is lowered to and locked at a position such that said saw blade is situated in a horizontal cutting position and at a desired depth of cut relative to a top surface of said log or other chainsaw cuttable substrate;

said lower toggle is released and said gauge assembly is brought to a resting position against said top surface of said cant or said log and locked in place, following which said upper toggle assembly is released and brought into an appropriate adjustment on said vertical member with a horizontal component of said corner brace of said upper lock assembly in a position resting atop said top plate of said saw positioning assembly body; said upper toggle lock assembly then being brought into a locked state at that level;

said lower toggle is next brought to a release state, elevated off said log and relocked, with said upper toggle now elevated above said body section, thus keeping said depth assembly up out of the way while a first cut is made;

following a return of said saw to a starting position behind and at a base end of said log, said lower toggle is again brought to a released state and said gauge assembly is lowered until said horizontal component of said corner brace of said upper lock is resting atop said body of said saw positioning assembly body, following which said lower toggle is relocked

said transverse guide rail assembly is then lowered to a position such that said foot of said depth gauge assembly is resting lightly on top of said log, at which point said transverse guide rail assembly is locked at that vertical height;

said lower toggle of said depth cut gauge assembly is again brought to a released state and said assembly is then raised out of the way followed by are locking of said lower toggle, thus leading to a holding of said depth gauge assembly up out of a contact with said log;

following which a second cut is made, this process is repeated until all cuts have been made.

### Double Acting Remote Chainsaws Trigger and Safety Switch Control Assemblies

A combination chainsaw safety switch and throttle trigger control assembly 84 FIG. 10b plus 85 FIG. 10a, comprises a remote control handle portion 84 FIG. 10b and a saw handle borne portion 85 FIG. 10a of said saw handle 406 FIG. 10a of said chain saw; said remote control handle portion being borne on the left gantry subframe 541 (best seen in FIG. 5d).

said remote control handle portion 84 FIG. 10b of said combination chainsaw safety switch and throttle trigger control assembly comprises a trigger control handle bracket 601 FIG. 10c, said bracket 601 is in a central affixation to travel control handle bracket 89c (best seen in FIG. 5d)—said bracket 601 serves to contain a control handle 87 FIG. 10b,

a flexible combination safety switch control cable and throttle trigger control cable 90 FIG. 10a,b is affixed at a forward facing end of said control handle 87 FIG. 10b; an opposite end of said cable 90 is in a first affixation to a pivotable safety switch engagement and connector element 602 FIG. 10a and then to a pivotable throttle trigger engangement and connector element 603 FIG. 10a; said pivotable engagement and connector elements 602,603 are situated within a trigger control frame section 604 FIG. 10a by a set of trigger control frame bolts 605 by which said bolts said frame section 604 is also clamped athwart an upper section of said saw handle 406 FIG. 10a;

an activation movement of said handle 87 leads to a retraction of said control cable 90 following which a projection of said pivotable safety switch engagement and connector element 602 compresses an integral safety switch 606 FIG. 10a leading to a release of said safety switch; subsequently, a further movement of said control handle 87 leads to an activating pressure being applied to a throttle control trigger 607 FIG. 10a of said chain saw by a projection of said pivotable throttle trigger engagement and connector element 603; said activation of said throttle control trigger leading to a change of a motor speed of said chain saw from an idling speed to an initial cutting speed;

a further activation movement of said control handle 87 leads to an advancement of said throttle trigger from an idling speed to an active cutting speed position; a still further activation of said handle 87 allows of a further increase of said motor speed; a reduction of said activation of said control handle leading to a reduction of said motor speed of said chain saw; allowing thus of a complete control of a full range control of a cutting speed of said saw motor and said saw blade, ranging from an idling speed to a full speed of said motor and sawblade;

a release of said control handles leads in turn to a return of said throttle to a power level of an idling state and a return to an activation of said safety control switch.

### Base Section of Sawmill Apparatus

Said set of longitudinal base section gantry tracks 505a,b,c,d,e,f FIG. 5e FIG. 5b of said base section 580 FIG. 5e of said sawmill apparatus 500 FIG. 5a comprise a track along which said gantry can be made to move in a forward or a rearward direction along a longitudinal length of a log in said mill, and further comprise the side rails/track portions of gantry subsections 581a,581b,581c FIG. 5e.

Gantry track subsections 581a and 581c comprise a pair of identically formed end frame sections, said end frame subsections representing respectively, a pre and log retention area gantry base section 581a and a post log retention area gantry base section 581c. A centrally situated modular subsection 581b FIG. 5e comprising a log retention portion of the sawmill apparatus.

End frame subsections 581a and 581c are of an identical size and configuration so a detailed description of subsection 581a will be presented as a representation of both.

Base section end section subframe 581a FIG. 5e comprises in part a pair of side piece rails 505a/b FIG. 5e, a right longitudinal track section 505a FIG. 5e and a left longitudinal track section 505b FIG. 5e; each of said track sections 505a,505b comprises an angle iron section situated with a 90.degree angle of said angle iron located at a topmost vertical orientation, both ends of said angle iron track sections resting atop a pair of channel iron cross support end pieces 584a,584b FIG. 5e, a rear end cross support end piece 584a FIG. 5e and a front end cross support end piece 584b FIG. 5e; a track connector section 610 FIG. 5g of each of said rail sections 505a,505b is seen as a short projection beyond the cross support end pieces 584a,584b in FIG. 5g.e;

a steel alignment tab 600 FIG. 5g is welded atop each end of each of said cross support end pieces and serves as an alignment guide insuring an exact situation of said longitudinal rails atop said cross end pieces. A threaded track connection hole 613 FIG. 5g is located near an end of each of said longitudinal rail connector pieces.

Said end frame subsections 581a and 581c also each further comprise in part a set of adjustable support and leveling foot assemblies 590 FIG. 5h; each of said leveling foot assemblies comprising a steel channel foot support strap 591 FIG. 5g, said support straps each being pierced by a central screw hole 615 FIG. 5g, designed for a placement of a central alignment screw 617 FIG. 5g that passes above into an end cross piece foot strap support alignment hole 616 FIG. 5g; once said alignment screw 617 has formed a connection between said end cross piece and said foot support strap, a pair of foot assembly bolts 592, 593 FIG. 5g can make a passage of through a pair of foot support strap holes 591a, 591b FIG. 5g in foot support strap 591 and thence can make a passage into and through a pair of cross support end piece attachment holes 596, 597 FIG. 5g located in said cross support end piece 584b, following which said bolts 592 and 593 can be anchored by a placement of a pair of foot assembly bolt nuts 592a and 592b FIG. 5g, completing an attachment of said foot assemblies to said base section of said gantry.

Each of said foot assembly bolts 592 and 593 FIG. 5g are seen to bear a pair of leveling nuts 598, 599 FIG. 5g, and, a head end of each of said bolts is in a welded affixation atop a pair of steel foot assembly foot plates 594,595 FIG. 5g.

A set of the adjustable support and leveling feet being in a location at each corner of said end frames 581a and 581b FIG. 5e, said leveling nuts 598,599 are used to provide a leveling of said base section when said sawmill is being set up. Other sets of said leveling foot assemblies are placed in a supporting attachment at intervals along the track sections of 505c and 505d of base subsection 581b FIG. 50

Note modular subsection 581c, as seen in FIG. 5e, partially comprises a right side longitudinal track section 505e and a left side longitudinal track section 505f, with said cross support end pieces comprising a rear cross piece 584c and a front cross piece 584d.

Modular subsection 581b FIG. 5e comprising said log retention portion of the sawmill apparatus comprises in part a pair of longitudinal track sections 505c and 505d FIG. 5e, a right side track 505a and a left side track 505b FIG. 5e.

Each of said longitudinal track sections of base section 581b being of a same length and structural configuration, a description of track section 505c will be presented as representative of both rail track sections 505c and 505d; there are no end cross pieces for base subsection 581b. Longitudinal track section 505c of subsection 581a comprises an angle iron section situated with a 90.degree angle of said angle iron situated in a vertical orientation; each end of track section 505c bearing a track connecting tab 601 FIG. 5g, which said tab is welded on an inner aspect of an external side wall of said angle iron section 505c; and, each of which said connecting tabs is tapped with a threaded track connecting tab bolt hole 614 FIG. 5g for a receipt of a connecting tab bolt 602 FIG. 5g.

When an end of said track section 505c FIG. 5g of said log containment section 581b is brought into an approximation with an end of track section 505a of said end subsections 581a of said base of said sawmill apparatus, said connecting tab bolt 602 passes through the connecting bolt hole 603 in the 505a longitudinal rail section, and thence into the connecting bolt hole 604 in the guide rail connecting tab 601; thus completing a union of the right section of the log bearing subsection 581b to the right section of the rear end subsection 581a FIG. 5g.

An exact same process involving identical parts as that described immediately prior serves to connect a front end of said track section 505c FIG. 5e to a rear most end of track section 505e FIG. 5e of front end base subsection 581c FIG. 5e, so no further description is provided for disclosure of that interconnection.

Referring again to FIG. 5e, a similar connection using exact same parts suffices for establishing a connection between the rear track section 505d of subsection 581b and track section 505b of base subsection 581a as well as the front end of track section 505d of the base subsection 581b to a rear end of track section 505f of the base subsection 581c; so no further description of those interconnections is provided.

An interconnection between a series of track sections 505a,c,e and 505b,d,f FIG. 5e of base subsections 581a, 581b and 581c FIG. 5e serves to provide a completion of a union of a full base framework 580 FIG. 5e of said base section of said sawmill apparatus, providing thus a rolling track for said gantry along a full horizontal length of said log or other such chainsaw cuttable material.

For a purpose of placing said log 503 FIG. 5b or other suitable substrate into said sawmill for cutting, after a selection of and a leveling of an appropriate site for a situation of said sawmill apparatus, said log can be placed into a centrally located positional situation and a series of wedges or other such log stabilization devices are placed in order to preserve an alignment of said log 503 FIG. 5b within said selected sawmill site;

An assembly of said base section 580 FIG. 5e is performed in a manner providing an alignment of said base section around and along a longitudinal length of said log;

said gantry, can now be placed into a situation atop base subsection 581a following which said travel control ropes of said gantry can be brought into an attachment with a set of corresponding end section cleats 104/107/110/113 FIG. 12 of said base section; said saw carriage assembly, mounted upon said transverse guide rails of said transverse guide rail assembly can then be brought into an attachment within said gantry; said chainsaw can then be attached to said saw attachment assembly of said carriage assembly and said vertical cut depth gauge placed into position; said remote trigger control attached between said saw and said remote trigger control handle and all is in a preparation for making a first cut in said log or other suitable substrate

Note: said series of four travel rope connector cleats 104 and 107 are seen at a front end of base subsection attached to forward end cross piece 584d and cleats 110 and 113 are seen at a rear end cross piece 584a in FIG. 12. These have been described prior in relation to the gantry forward travel assembly.

In an alternative manner, after a selection of and a leveling of an appropriate site for a situation of said sawmill apparatus, said base section 581a/b/c FIG. 5f can be set up in a partial manner comprising a full assembly of said end sections 581a/c FIG. 5f, which said end sections are in a completed attachment with said left side track section 505d FIG. 5f of said log containment section 581b; said right side track section 505c FIG. 5f being in an unattached state relative to said end sections is in a location away from said sawmill base section; said log is then placed into a centrally located positional situation and a series of wedges or other such log stabilization devices are placed in order to preserve an alignment of said log 503 FIG. 5b within said base section of said selected sawmill site; at this point said right side track section 505c is brought into an alignment with and an attachment to end section tracks 505a/e, creating thus a completion of said base section;

following which said gantry, can now be placed into a situation atop base subsection 581a, following which said travel control ropes of said gantry can be brought into an attachment with a set of corresponding end section cleats 104/107/110/113 FIG. 12 of said base section; said saw carriage assembly, mounted upon said transverse guide rails of said transverse guide rail assembly can then be brought into an attachment within said gantry; said chainsaw can then be attached to said saw attachment assembly of said carriage assembly and said vertical cut depth gauge placed into position; said remote trigger control attached between said saw and said remote trigger control handle and all is in a preparation for making a first cut in said log or other suitable substrate

### Alternative Body Components of Carriage Assembly

The carriage component of the invention can be modified to allow of a use of the invention within other sawmill apparatuses having a transverse guide rail component differing from that of the current invention.

In a first alternative embodiment a body assembly comprising in part an elongated, parallelepiped shaped body member, is of a design for a use with a transverse guide rail assembly having a pair of angle iron guide rails; a rear and a front guide rail each of which has one wall of the angle iron facing vertically, a pair of vertical slots near the front and the rear of the base of the body section, and, partially extended up the side walls of the body section could replace the circular holes in the side walls of the preferred embodiment described prior; the vertical slots would serve as a guide for the carriage to slide along the transverse guide rails. With said body situated with said base slots straddling said angle iron guide rails, a full width movement of said body section would be possible and a locking of an integral locking mechanism of said body section could allow a fixation at any point along said guide rails; a hinged L frame chainsaw positioning element attached to the body section would allow cutting in either of a vertical or a horizontal planar attitude.

Alternatively, a wheeled parallelepiped carriage framework component comprising in part an elongated, six faced, open sided box having a bottom subsection, a top subsection, a left side subsection, a right side subsection, a rear face subsection and a front face subsection;

In which each of which said front and rear face subsections is in an attachment with a set of at least three externally attached wheels of matching size via a set of axle bolts; said wheels being in a positional situation at three like corners of each of said rear face and front face walls; forming thus a minimally six wheeled carriage;

since said carriage is designed to provide an allowance of a selective positioning of a blade of a chainsaw in either a perpendicular or a horizontal plane of cutting orientation, for purposes of clarity said wheel pairs shall be described as wheel pair A, wheel pair B and wheel Pair C; a rolling plane of each of said wheels is in an alignment along said front and said rear faces of said carriage and along said pair of transverse guide rails of said gantry;

in a first functional pairing, with said carriage in a situation upon said guide rails such that said blade of said saw is in a planar attitude for a making of a vertically oriented cut or series of cuts, said wheel pair A is in an inoperative position off of the guide rails; wheel pairs B and C are in an operative position, both sets being in contact with the guide rails;

after a lifting of the carriage off the guide rails, and a turning through a 90.degree arc creating thus a second functional pairing, with said carriage in a situation upon said guide rails such that said blade of said saw is in a planar attitude for a making of a horizontally oriented cut or series of cuts, said wheel pair C is in an inoperative position off of the guide rails; wheel pairs B and A are in an operative position, both sets being in contact with the guide rails;

In a third alternative embodiment, for a Sliding Rail Carriage Component, carriage framework component comprising in part an elongated, six faced, open sided box having a bottom subsection, a top subsection, a left side subsection, a right side subsection, a rear face subsection and a front face subsection;

with two adjacent sides of said front and rear face subsections being in a fixed attachment atop an angle iron rail situated with the 90.degree angle in a vertical alignment and a V shaped opening facing downward; it is readily seen that a placement of one open sided inverted V rail on an angle iron guide rail would align the body section such that a cutting blade would be in a situation for making a vertical cut; a repositioning of the body section on the second V rail, which is situated at a 90.degree angle to the first V rail, would situate a cutting blade for making a horizontal cut.

I claim:

1. In a sawmill apparatus, an improvement comprising a saw carriage assembly, which said carriage assembly comprises in part a body section and a chainsaw bar attachment assembly;
said bar attachment assembly allowing of a removable but secure affixation of a chain saw of said sawmill apparatus to said body of said saw carriage assembly; said chain saw comprising in part a saw motor, a saw motor end, a saw handle, a saw blade bar, a saw blade and a saw bar nose end;
said body section comprising in part an elongated, parallelepiped shaped body member, said body member being in a hinged affixation, to a saw blade orientation component of said body section, by virtue of which said saw blade orientation component is allowed a selectable positioning and maintenance of a blade of said chain saw in either of a vertical or a horizontal planar cutting attitude;
said body section of said carriage framework further providing for a moveable attachment of said carriage along a pair of transversely situated guide rails of a transverse guide rail assembly of a gantry of said sawmill apparatus; said transverse guide rail assembly allowing of a movement of or alternatively, a fixation of said chainsaw at a selected horizontal position within a full width of said gantry.
a vertical level control assembly of said gantry allows of a movement of or alternatively, a fixation of said chainsaw at a selected vertical level within a full vertical height of said gantry of said sawmill.
In combination, said saw carriage, transverse guide rail and vertical level control assemblies provide an allowance of a positioning of said chainsaw at any point along a full width and at any point within a full vertical height of said gantry of said mill apparatus; allowing thus of a making of a perpendicularly oriented cut or series of cuts, or, a horizontally oriented cut or series of cuts of a through cut or partial depth nature in a selectably alternating manner in a longitudinal direction along a full length of a log or other chainsaw cuttable substrate with said log being left in an unturned and original position within said sawmill apparatus as well as providing an ability for a making of a full height and width cant from said log with said log being left in an unturned and original position within said sawmill apparatus.

2. The body section of the carriage component of claim 1 further comprising in part a pair of opposed sidewalls of said elongated, parallelepiped shaped body member, each of said side walls of said body section being pierced by a pair of circular openings, which said circular openings are in an alignment on an interior facing aspect of said side walls, with an associated bushing plate; and, which said bushing plates provide a gliding surface for a passage through said body member of said pair of guide rails, a rear transverse guide rail and a front transverse guide rail of said transverse guide rail assembly of said gantry;
said body section further comprising an integral lateral position locking assembly mechanism; said lateral position locking mechanism comprising a cam rotatably mounted in said body of said carriage such that a forward movement of a cam handle of said cam leads to a cam's locking pressure being applied to a lock block plate of said locking assembly, which said lock block plate in turn applies a locking pressure against said rear transverse guide rail of said gantry; said locked position being maintained until a back tilting of said cam handle leads to a disengagement of said lock block from said rear transverse guide rail creating said freedom for said carriage to be moved in either a right or left direction within said full width of said gantry;
said body further comprising in part a chain saw attachment assembly receiver cutout for receiving and being rotatably affixed via a hinge attachment axle bolt to a hinge axle block of said hinged saw blade orientation assembly; a swivel lock component situated on a top plate of said body, said swivel lock component serving to allow a selectable locking and holding of said saw blade orientation assembly such that said blade of said chain saw is held in either a horizontal or a vertical plane of orientation;
said body further comprising in part a pair of vertically superimposed depth gauge openings, a top plate and a bottom plate depth gauge opening for allowing a placement of a removable horizontal cut thickness gauge in a passage from below to above through said body section; a toggle clamp lock assembly located on a right side wall of said body serving to afford a stable fixation of said gauge at a selectable height within said body section.

3. The saw blade orientation component of claim 1 comprising an L shaped hinge frame;
said hinge frame comprising in part a longer and a shorter side element;
said longer side element of said hinge frame being placed into a moveable affixation to a side of said body of said carriage by a hinge axle bolt passing through an attachment assembly receiver cutout in said body section and a hinge axle block of said longer side element;
an affixation of one or the other of said longer or said shorter frame elements being afforded by a pair of swivel lock bolt slots, a lock bolt slot situated respectively at a top edge of each of said shorter and longer side elements of said hinge frame; each of said slots being designed to receive a swivel lock bolt of a swivel lock component of said body section, which said swivel lock bolt when in an engagement within one or the other of said longer or shorter L shaped frame sections and locked in place by an activation of a swivel lock handle of said swivel lock component, serves to hold said saw carriage in said stably maintainable attitude within either said horizontal or said vertical plane of orientation of said saw blade;
a release of said swivel lock bolt's said locking and affixation from within either of said swivel lock bolt slots providing an allowance of selectably alternating a planar attitude of said hinged L shape frame section and thus of said saw blade between said perpendicular or said horizontal planar attitudes of alignment of said blade;
said L shaped hinge frame of said orientation component further comprising a hinge alignment fine tuning assembly, which said assembly comprises in part a pair of set screws located in a pair of threaded set screw holes situated in a position within and beneath a top edge of said longer side element of said hinge frame, and, a like pair of said set screws situated in a like position in said shorter side element of said saw blade orientation component;
following said engagement of said swivel lock bolt into one or the other of said pair of swivel lock bolt slots with said blade being held is either of said horizontal or vertical planar orientations, but prior to a tightening of said toggle lock bolt into said slot; an involved pair of said set screws being capable of being brought into an adjustment such that an internal end of said involved pair of said set screws is brought to a rest against an outer aspect of a side plate of said body section of said chainsaw attachment and positioning assembly;
an inward or an outward movement adjustment of said pair of involved set screws against said side wall leads to an alteration of a vertical or a horizontal alignment of said hinge plate, and thus to an alteration of a vertical or a horizontal alignment of said saw blade; following which a tightening of said swivel lock bolt into one or the other of said pair of swivel lock bolt slots results in a fixation of said saw blade at said altered vertical or horizontal planar attitude.

4. The chainsaw bar attachment assembly component of Cl.1 comprising a bar clamp connector arm, an upper end of said connector arm being in an affixation above to a longer side plate of an L shaped hinge frame of said body section of said carriage by a pair of connector arm brackets and a set of connector arm bolts and nuts; a lower, terminal end of said bar clamp connector arm being affixed by a welded joint atop of a pair of inverted U shaped bar clamp body sections; said bar clamp body sections having an open space between their adjacent sides and forming a top section of a skid assembly; said skid assembly having a lower segment, a pair of foot plates welded to said body sections in such manner that a space exists for an insertion of said chainsaw bar between said foot plates; a tightening of a pair of clamping plate adjustment bolts of a pair of chainsaw bar clamping pads situated and affixed in an opposed manner between said upper and lower clamp assembly body sections serves to afford a holding of said chain saw bar firmly within said clamp assembly; said chainsaw bar attachment component allowing of a stable but removable affixation of said chainsaw to said body section of said carriage component.

5. The gantry of claim 1 comprising in part a gantry main frame which said main frame comprises in part a set of four vertical main frame supports which said main frame supports form a rectilinear vertical framework of said gantry; each of which supports being in an attachment to a vertical level adjustment assembly O.C. tube, said main frame vertical supports being held as well in an attachment with a pair of transverse horizontal top main frame members and a set of three longitudinal horizontal top main frame members, said top frame members being interconnected in a manner such as to form a rectangular top frame of said gantry main frame;
a left front and a left rear vertical main frame support terminate below in a welded attachment to a left side fender member and a right front and a right rear vertical main frame support terminate below in a welded attachment to a right side fender member;
said left side and right side fender members each containing a pair of gantry wheel and axle sets, a rear gantry wheel and axle and a front gantry wheel and axle;
the whole being so arranged and affixed in and between each other as to form a stable superstructure situated upon and capable of being moved in a forward or a backward manner along said base section of said sawmill;
a vertical level control assembly of said gantry provides a control of a vertical height of said transverse guide rail assembly within said gantry; said guide rail assembly being held in an attachment to said rectilinear vertical framework of said gantry at a left rear, left front, right rear and right front end of said pair of transverse guide rails;
said vertical level control assembly being held in such attachment by, respectively; by a set of four pairs of transverse guide rail vertical travel-guide bolts;
said guide bolts being respectively situated and held within a guide bolt bracket with a head of each of said guide bolts of each of said brackets being held moveably within an O.C. tube slot of said O.C. tubes that are in said attachment with said gantry's vertically situated main frame support elements;
said situation of said bolt heads within said slots of said OC tubes serving as a moveable attachment allowing of an upward or a downward movement along a vertical length of said gantry by said vertical level control assembly and said affixed transverse cross rail assembly following a rotation of a left side vertical level control handle;
said vertical level control assembly further comprising in part a left side rear vertically oriented stationary climbing chain, a left side front vertically oriented climbing chain, a right side rear vertically oriented stationary climbing chain and a right side front vertically oriented climbing chain; each of said chains being in a fixed attachment at a top and a bottom end to said gantry;
said assembly further comprising in part a left side climbing chain sprocket axle and a right side climbing chain sprocket axle; each of said climbing chain sprocket axles bearing a rear end climbing chain sprocket and a front end climbing chain sprocket; each of which said sprockets being capable of a movement in an upwards or a downwards direction along said stationary climbing chains when a rotation of a left side climbing chain control handle initiates a turning of said left climbing chain sprocket axle; each of said climbing chain sprockets being held in an engagement with a half circle loop of said respectively associated climbing chains by an upper idler wheel and a lower idler wheel;
said idler wheels being bolted within said guide bolt brackets such that said idler wheels are in an exact vertical alignment respectively above and below said associated climbing chain sprocket; said idler wheels serving to provide a compensation for temporary fluctuations in tension and maintenance of said engagement of said climbing sprockets with said stationary chains.
a continuous loop cross chain of a cross chain assembly is in an affixation around a pair of cross chain sprockets, which said sprockets are affixed near a forward end of said left and a forward end of said right side climbing chain sprocket axles; said cross chain imparting a simultaneous directional and vertical length of travel to both said axles whenever a rotation of said left side axle is initiated by said turning of said climbing chain control;
an idler arm assembly of said cross chain assembly comprising a slotted, horizontal idler arm affixed to a lateral, forward end of said transverse guide rail assembly; a central most idler wheel is held in a fixed position at a central most end of said idler arm; a lateral most idler wheel being held in an adjustable affixation within said horizontal slot of said idler arm; said cross chain making a passage beneath one of said idler wheels and over a top of said other idler wheel; a rightward or leftward movement of said lateral most idler wheel serving to accomplish an increase or a decrease of tension on said cross chain, thus serving to provide an appropriate tension adjustment of said cross chain.
a vertical control assembly toggle lock mechanism is situated at a rearmost end of both said left and said right climbing chain sprocket axles; a selective locking of either of said toggle locks serves to provide a locking of said vertical control assembly at any given elevation along a full vertical height of said gantry; following a release of said selectively locked toggle lock a rotation of said travel mechanism control handle again serves to cause said movement in an upwards or downwards direction of said climbing chain sprockets.

6. The transverse guide rail assembly of Cl.1 comprising in part said pair of transversely situated guide rails, a rear transverse guide rail and a front transverse guide rail; said transverse guide rails being in an affixation via a set of U-bolts to a left side guide rail cross support member and a right side guide rail cross support member; said left side cross support member comprising an O.C. tube with an O.C. tube opening facing left and a right side guide rail cross support member being an O.C. tube with an O.C. tube opening facing right;
a pair of O.C tube bolt heads are in a situation within said O.C tube openings of each of said longitudinal support cross members with a threaded end of said bolts making a passage through and an affixation by a set of nuts at a lateral aspect of a set of four vertical control level assembly connector brackets;
forming thus a mounting platform upon which said chain saw attachment and positioning assembly can be placed in a stable but removable manner;
said set of connector brackets serving as an interconnection point for a vertically moveable affixation of said transverse guide rail assembly to said gantry by said set of four pairs of O.C. tube connector bolts.

7. The transverse guide rail assembly of claim 6 in which is afforded a modified assembly for an adaptation of said guide rail assembly allowing a use in an already existing sawmill having a pair of longitudinal carriage support rails; an intact removal of said transverse guide rail section from said gantry is allowed following a loosening of the heads of said four paired sets of OC tube attachment bolts in said lower right and left side guide rail cross support member O.C. tubes;
a pair of wheel and axle assemblies are then placed in an affixation on a right side wheel adaptor conversion plate and a pair of wheel and axle assemblies are also placed in an affixation on a left side wheel adaptor conversion plate; said axles of said assemblies comprising a set of O.C. tube connector bolts, each of said bolts being situated with a head end in a placement either within a right or a left side guide rail cross support member; a tightening of the heads of said four O.C. tube connector bolts within said right and said left side transverse guide rail cross support members completes said adaptation necessary for said use of the saw carriage of this invention within other sawmill apparatuses having longitudinal carriage guide rails.

8. The sawmill apparatus of Cl. 1 further comprising a base section, said base section serving as a rolling track for said gantry along a full horizontal length of said log or other such chainsaw cuttable material; said base section of said gantry comprising in part a series of three modular, inter-connectable, gantry track subsections, said subsections comprising a pair of identically formed end frame sections and a centrally situated modular subsection; said end frame subsections representing respectively, a pre and post log gantry retention base section; and said central subsection comprising a log retention portion of said base section;
each of said end frame sections comprising in part a track section comprising a right and a left longitudinal angle iron guide rail; said angle iron guide rails comprising an angle iron section situated with a 90.degree angle of said angle iron located at a topmost vertical orientation; both ends of said angle iron track sections; resting atop a pair of channel iron cross support end pieces, a rear end cross support end piece and a front end cross support end piece;
a track connector section of each of said track sections is in a projection for a short distance beyond said cross support end pieces; a steel alignment tab welded atop each of said cross pieces serves as an alignment guide insuring an exact alignment of said track sections atop said cross end pieces;
a set of two travel rope connector cleats are in an attachment at a front end left, a front end right of a forward facing end of said front end subsection; a set of two travel rope connector cleats are in an attachment at a rear end left, and at a rear end right of a rearward facing end of said rearmost end subsection;
an interconnection between a series of track sections of said front and rear end subsections to a right and a left track section of said centrally situated modular subsection is afforded by a series of connecting bolts serves to provide a completion of a full base framework of said sawmill apparatus.

9. The gantry of Cl.1 further comprising a mechanically assisted travel assembly; said gantry travel mechanism comprising in part a gantry travel control handle in an attachment to a control handle axle of a dual speed gantry travel transmission; said transmission comprising a set of gears associated with said control handle axle and a transmission axle,
an adjustment of said gears allowing of a selection of a slow or a fast speed of travel, or alternatively of a neutral gear allowing no movement in either of a forward or a rearward direction of travel;
a vertical travel chain having a lower loop end in a situation around a travel control gear of said control handle axle passes upwards to an attachment around a sprocket affixed to an upper rear travel control axle of said gantry, which said upper rear travel control axle is held in a connection with an upper front travel control axle by an upper travel sprocket cross chain such that a rotation of said travel control handle results in a like rotation of both upper travel control axles,
both of said upper travel control axles being held in a rotatable affixation atop said gantry by a set of pillow blocks; said axles respectively providing a fixed attachment point for a pair of front end travel ropes and a pair of rear end travel ropes; a forward end of each of said front end travel ropes being in a fixed attachment to one of a pair of front left travel rope cleats situated at a front end of said base of a base of said gantry; a rear most end of each of said rear end travel ropes being in a pair of rear end travel rope cleats of a base of said sawmill;

10. The horizontal cut thickness gauge of claim 2 comprising an L shaped frame member said L shaped member comprising in part a pair of rectangular O.C. tube elements held together by a corner brace and a set of nuts and bolts; a shorter, horizontal element comprising a foot section of said gauge;
after a passage of a longer vertical element upwards through said pair of openings in said bottom and top plates of said body section, said toggle clamp locking assembly attached to said side wall of said body section can be brought into a locking activation such that it holds said vertical member with said foot of said gauge projecting laterally towards and at a selected horizontal level relative to said log;
an upper toggle lock assembly is then affixed in said vertical L shape frame element at a point superior to said top plate preparing said gauge for establishing a repeated series of cuts at a desired depth of cut relative to a top surface of said log after an appropriate adjustment of and locking of said upper locking assembly in a position atop said top plate of said saw positioning assembly body;
allowing thus for an automatic provision of an ability for making a series of multiple horizontal cuts at a predetermined thickness of cut throughout a full or a partial vertical height of said log or said cant.

11. The sawmill apparatus of Cl.1 further comprising a secondary bar nose end clamping assembly for a use in providing a stabilization of said saw bar nose end of said saw blade bar when cutting at a partial depth into said log using only a bar nose end section of said blade; or, alternatively for a use when making horizontally aligned through cuts in a log of an extreme girth wherein a bar nose end stabilization of an extra long saw blade must be used;
said bar nose end clamping assembly comprising a pair of inverted U shaped bar clamp body sections, which said body sections are joined by a set of bar clamp body bolts situated near a front and a rear extremity of said body sections, said conjoined body sections otherwise having an open space between their adjacent sides and forming a top section of a skid assembly; said skid assembly having a lower segment, a pair of foot plates welded to said body sections in such manner that a space exists for an insertion of said chainsaw bar between said foot plates; a tightening of a pair of clamping plate adjustment bolts of a pair of chainsaw bar clamping pads situated and affixed in an opposed manner between said upper and lower skid assembly body sections serves to afford a holding of a bar nose end of said chain saw bar firmly within said bar nose end clamp assembly.

12. A process for making a full width and full vertical height cant from a log or other substrate suitable for cutting by a chainsaw with said log being left in an original, unturned position within a base section of a sawmill apparatus; said process also allowing of a making of multiple sections of dimensional lumber with a minimal number of sawing passes using a combination of vertical and horizontal through cuts performed by said chain saw with said sawblade in an orientation for making cuts in a longitudinal direction in said log;
said process of full height and width cant formation comprising:
1. a selection of and a leveling of an appropriate site for said sawmill apparatus followed by a centralized placement and a stabilization of said log within said sawmill site;
2. a measurement of said log's diameter and a determination of an optimal cutting pattern for making a pair of two parallel, perpendicular side cuts and a top horizontal cut;
3. a base section of said mill assembly is assembled in a manner providing an alignment of said base section around and along a longitudinal length of said log, said assembly of said base section comprising a connecting of a rectilinear rear end modular component, a non-log containing section; to a forward end of a pair of longitudinal travel rails of said rear end component being in an attachment with a rearward end of a pair of travel rails of a central modular section, a log-containing section; then a connecting of a forward end of said central module travel rails into an attachment to a rear facing end of a pair of travel rails of a rectilinear front end modular component, said front end component comprising a non-log bearing section; an adjustment of a series of leveling feet situated in an attachment to and beneath said longitudinal travel rails of said base section allow a leveling of said base section;
4. a gantry of said sawmill can be brought into an assembled state; said gantry assembling comprising a conjoinment of a set of parts of a main frame; said main frame comprising in part four O.C. tube bearing vertical main frame supports, said vertical frame members being conjoined above with a set of gantry top support cross pieces and said vertical members being conjoined below with a pair of fender members, each of said fenders bearing a pair of gantry wheel and axle sets; said gantry components further including a left rear control handle subframe, a set of upper gantry travel control assembly components, a set of transverse guide rail assembly components and a set of vertical level control assembly components; following said assembling of said gantry, each of said pairs of wheels is placed into a situation atop said rails of said rearmost non-log retaining base sub section; following which a set of four travel control ropes of said gantry's travel control assembly can be brought into an attachment with a set of corresponding end section cleats of said base section;
5. a saw carriage assembly of the invention, mounted upon a pair of transverse guide rails of said transverse guide rail assembly can then be brought into an attachment within said gantry;
6. said chainsaw can then be brought into an attachment to a chain saw attachment component of a body section of said carriage assembly, and a vertical cut depth gauge assembly of said body section can be brought into an adjustable affixation with said body section;
7. a dual action remote throttle trigger and safety switch control of the invention can be brought into an attachment between said saw and a remote trigger control handle of said gantry and all is in a preparation for making a first cut in said log or other suitable substrate
8 a first orientation, a horizontal orientation of said saw blade by said carriage device allows of a making of a top, horizontal cut across said log;
9. a movement of said gantry along said travel rails of said base section being afforded by said mechanically assisted travel control assembly, which assembly further comprises in part a dual speed travel control gearbox and a travel control handle that is used to provide said forward movement in a cutting pass along a full length of said log and then a faster movement, a rearward, non-cutting movement of said gantry along a full horizontal length of said log;
10. following which with said gantry once again in a position atop said rearmost non-log retaining sub section of said gantry, an unlocking of an L shaped hinge frame of a hinged, saw blade orientation assembly of said carriage device allows of an alteration from said horizontal blade orientation to a vertical blade orientation;
11. after a locking of said hinge frame with said blade now being held in said vertical planar attitude, said mechanically assisted travel mechanism is used in a making of a pair of parallel perpendicular side cuts, a right side cut and a left side cut; completing thus a making of said cant with only three cutting passes of said chainsaw and with said log left in said original unturned position within said sawmill apparatus;
12. following said creation of said cant, a series of full depth cuts are made in said cant with said blade of said chainsaw held in said vertical cut planar orientation by said saw carriage of said sawmill device;
13. a reorientation of said saw blade orientation from said vertical planar cutting orientation to said horizontal cut planar orientation by an appropriate adjustment of said L shaped hinge frame allows of a making of a series of horizontal through cut passes; a desired thickness of said horizontal cuts being automatically provided by a horizontal cut thickness gauge of said body of said carriage assembly; each of which said horizontal through cuts results in a formation of multiple sections of dimensional lumber allowing thus said formation of said maximal number of square or rectangular pieces of dimensional lumber from said parent log or other such chain saw cuttable substrate with a minimal number of sawing passes.
